(19) United States
(12) Patent Application Publication
(10) Pub. No.: US 2018/0276304 A1
(43) Pub. Date: Sep. 27, 2018

(54) ADVANCED COMPUTER IMPLEMENTATION FOR CRAWLING AND/OR DETECTING RELATED ELECTRONICALLY CATALOGUED DATA USING IMPROVED METADATA PROCESSING

(71) Applicant: YISSUM RESEARCH DEVELOPMENT COMPANY OF THE HEBREW UNIVERSITY OF JERUSALEM LTD, Jerusalem (IL)

(72) Inventors: Alon PELED, Raanana (IL); Steven KARAS, Givatayim (IL)

(73) Assignee: YISSUM RESEARCH DEVELOPMENT COMPANY OF THE HEBREW UNIVERSITY OF JERUSALEM LTD, Jerusalem (IL)

(21) Appl. No.: 15/761,917

(22) PCT Filed: Sep. 21, 2016
(86) PCT No.: PCT/IL2016/051052

§ 371 Date: Mar. 21, 2018

Related U.S. Application Data
(60) Provisional application No. 62/221,316, filed on Sep. 21, 2015.
(60) Provisional application No. 62/221,353, filed on Sep. 21, 2015.

(51) Int. Cl. G06F 17/30

(52) U.S. Cl. CPC G06F 17/30867; G06F 17/3089; G06F 17/30887

(57) ABSTRACT

Some embodiments are directed to a or method including all of or any subset of a site poker, including a crawler that identifies known catalog software running on a server; and a Crawler/s operative to extract metadata from a given catalog platform for computer storage, including functionality for at least one of: marking in the computer storage, where that metadata came from; functionality for associating additional catalog level metadata with the metadata extracted; and functionality for marking external links for feeding at least some of the external links back into the site poker.

### CROSS REFERENCE TO RELATED APPLICATIONS

This application is a national phase filing under 35 C.F.R. § 371 of and claims priority to PCT Patent Application No. PCT/IL2016/051052, filed on Sep. 21, 2016, which claims the priority benefit under 35 U.S.C. § 119 of U.S. Provisional Patent Application No. 62/221,316, filed on Sep. 21, 2015, and U.S. Provisional Patent Application No. 62/221,353, filed on Sep. 21, 2015, the contents of each of which are hereby incorporated in their entireties by reference.

### BACKGROUND

Some embodiments relate to data processing, and more particularly, to crawling.

US Patent Application No. 2014/280009 discloses methods and apparatus to supplement web crawling with cached data from distributed devices.

US Patent Application No. 2013/091118 discloses a method of performing an audit of auditable objects within webpages of a website

US Patent Application No. 2011/029504 discloses a facility for exposing an index of private documents.

US Patent Application No. 2010/293116 discloses systems and methods of URL and anchor text analysis for focused crawling.

US Patent Application No. 2002/052928 discloses computer processing means and methods for searching and retrieving Web pages to collect people and organization information.

A Website is intended to include a collection of content items (i.e., files, images, videos, etc.) that are hosted on one or more web servers, usually accessible via the Internet. However, multiple content items of a website may be identical or nearly identical, and thus, duplicative content. For instance, a webpage on a website may be associated with several secondary content items with the same or similar content (e.g. a webpage with the print version of the original webpage. Accordingly, results of a web crawling can include duplicative content. Problems of detecting relationships between content items have been recognized in the conventional art and various techniques have been developed to provide solutions, for example:

US Application No. 2009/125516 discloses systems, methods and computer program products for detecting different content items with similar content by examining the anchor text of the link.

US Application No. 2012/047161 discloses a method including receiving web page identifiers associated with a website and determining whether the web page identifiers identify redundant web pages of the website.

US Application No. 2010/076954 discloses detecting duplicate documents in a web crawler system. Upon receiving a newly crawled document, a set of documents, if any, sharing the same content as the newly crawled document is identified. Information identifying the newly crawled document and the selected set of documents is merged into information identifying a new set of documents. Duplicate documents are included and excluded from the new set of documents based on a query independent metric for each such document. A single representative document for the new set of documents is identified in accordance with a set of predefined conditions.

US Application No. 2008/235163 discloses a method for online duplicate detection and elimination in a web crawler.

Other state of the art systems include those described in the following US patent publications: US2016179954, US2016070791, US2016034757, US2015324459 and US2013124972.

Conventional technology constituting background to some embodiments of the presently disclosed subject matter is also described in the following publications inter alia:

State of the art techniques for dimensional modeling of enterprise data warehouses are described, for example, in Kimball, R. “The Data Warehouse Toolkit”, published by Wiley in several editions from 1996 on.

The entity-relationship model and Inmon data warehouse technology, e.g., as described in http://www.zentut.com/data-warehouse/kimball-and-inmon-data-warehouse-architectures/, may also be within in the field of some embodiments of the presently disclosed subject matter. Decades ago, the Federal Government made both weather data and the Global Positioning System (GPS) freely available. More recently all data collected by the American government was required to become “open by default”, except for personal and national security data. As a result, 200,000 datasets from 170 publishing entities have been posted on data.gov and similar efforts have been undertaken by dozens of other countries.

Datasets published on open-data portals sometimes use CKAN software, developed by Open Knowledge.

The Economist (e.g. at economist.com/news/international/21678833-open-data-revolution-has-not-lived-up-expectations-it-only-getting) has said that the scale of the data deluge is astonishing but relatively little has been achieved e.g. because the open data is useless and/or hard to navigate even for data engineers let alone for laypersons, and/or because mining open data for insights is itself nontrivial not to speak of putting the insights once gained to good use. Also, useful data is often missing its “metadata” without which the raw information cannot be used. Finally, official data is sometimes shoddy leading potential end-users to prefer to collect information on their own. The Economist complains that “Working out which source is most useful is tricky when dozens have the same information”.

GIS (Geographical Information System) may be regarded as a custom version of Google maps with extra layers for various datasets and ensuing metadata, which operates at least in part on a component level.

Junar is a data visualization tool. CKAN software supports provisioning of open data catalogs and, sometimes, visualizations and APIs.

Socrata has been described as “a software-as-a-service platform that provides a cloud-based solution for open data publishing and visualization. All Socrata datasets are API-enabled and . . . developers . . . can use SODA to create apps, analyses, and complex visualizations atop any Socrata dataset. The SODA server . . . could be self-provisioned. The New York City open data site is a great example of a Socrata site”.

### SUMMARY

Indexing the internet can be provided using a web crawler, e.g., an application that visits websites and indexes or records the contents of the websites visited.

The disclosures of all publications and patent documents mentioned in the specification, and of the publications and patent documents cited therein directly or indirectly, are hereby incorporated by reference. Materiality of such publications and patent documents to patentability is not conceded

Some embodiments seek to provide a computer-based system and method capable of websites crawling for catalogues and configured substantially as described herein with reference to the drawings.

Some embodiments seek to provide a computer-based system and method capable of detecting relationship between web content items

Some embodiments seek to provide a system and method for crawling and/or detecting related electronically catalogued data such as but not limited to open data, including de-duping, using improved metadata processing.

Some embodiments seek to improve any technology based on dimensional modeling of enterprise data warehouses by providing methods operative to model, store, and rapidly retrieve data about catalogs, publications, their components, downloads and urls e.g. for open-data and other use cases.

Some embodiments of the presently disclosed subject matter seek to provide at least one processor in communication with at least one memory, with instructions stored in such memory executed by the processor to provide functionalities, which are described herein in detail.

Some embodiments seek to provide a system operative to perform at least some of: translate and extract metadata, putting metadata into structured form, and “cleaning up” geospatial and temporal bounds, consolidate metadata (e.g. from plural instances of a single information asset) into a single system.

Some embodiments seek to provide an internal consolidated catalog for agencies, installed inside their infrastructure, typically without public access.

Some embodiments seek to provide a search engine, typically Publicly available, which may include recommendations and alerts for new data generated using relationship discovered as described herein. The engine typically includes a single search engine with results that come from multiple underlying catalogs.

There is thus provided, in accordance with at least one embodiment of the presently disclosed subject matter, a system including at least some or all of a site poker, further including a specialized crawler that identifies specialized catalog software running on a server; a Crawler/s operative to extract metadata from a given catalog platform for computer storage, including functionality for at least one of: marking in the computer storage, where that metadata came from; functionality for associating additional catalog level metadata with the metadata extracted; and functionality for marking external links for feeding at least some of the external links back into the site poker.

Also provided, in accordance with at least one embodiment of the presently disclosed subject matter, is a method or system which automatically identifies catalogs running on a host in a network environment by crawling websites, the method or system including: for at least one domain, downloading pages, adding discovered links back to a queue; and reporting publications to a staging system.

Also provided, in accordance with at least one embodiment, is a computerized relationship discovering method or system including all or any subset of the following: generating a list of “potential” publications, which may have some relationship to a current publication, For each pairing of current publication and potentially related publication examining available metadata which pertains to the relevant publications, to determine relationships between publications and storing relationship/s with references to both publications, tracking behavior of end users who search through information assets the system has discovered, and use for creating relationships between publications, Using Specific information known about a user's downloading behavior to mark relationship/s as stronger or weaker reflected in high/low confidence levels where relationships whose confidence exceeds a threshold are stored; and de-duping publications thereby to generate a set of information assets.

Also provided, in accordance with at least one embodiment of the presently disclosed subject matter, is a computer program product, including a non-transitory tangible computer readable medium having computer readable program code embodied therein, the computer readable program code adapted to be executed to implement any method claimed or described herein, the method including the following operations as described herein.

Also provided, excluding signals, is a computer program including computer program code means for performing any of the methods shown and described herein when the program is run on at least one computer; and a computer program product, including a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes or general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display, and input devices may be used to process, display e.g. on a computer screen or other computer output device, store, and accept information such as information used by or generated by any of the methods and apparatus shown and described herein; the above processor/s, display and input device including computer programs, in accordance with some or all of the embodiments. Any or all functionalities of some embodiments shown and described herein, such as but not limited to operations within flowcharts, may be performed by any one or more of at least one conventional personal computer processor, workstation or other programmable device or computer or electronic computing device or processor, either general-purpose or specifically constructed, used for processing; a computer display screen and/or printer and/or speaker for displaying; machine-readable memory such as optical disks, CDROMs, DVDs, Blu-Rays, magnetic-optical discs or other discs; RAMs, ROMs, EPROMs, EEPROMs, magnetic or optical or other cards, for storing, and keyboard or mouse for accepting. Modules shown and described herein may include any one or combination or plurality of a server, a data processor, a memory/computer storage, a communication interface, and a computer program stored in memory/computer storage. The term “process” as used above is intended to include any type of computation or manipulation or transformation of data represented as physical, e.g. electronic, phenomena which may occur or reside e.g. within registers and/or memories of at least one computer or processor. The term processor includes a single processing unit or a plurality of distributed or remote such units.

The above devices may communicate via any conventional wired or wireless digital communication devices, e.g., via a wired or cellular telephone network or a computer network such as the Internet.

The apparatus of the presently disclosed subject matter may include, according to some embodiments, machine readable memory containing or otherwise storing a program of instructions which, when executed by the machine, implements some or all of the apparatus, methods, features and functionalities of some embodiments shown and described herein. Alternatively or in addition, the apparatus may include, according to some embodiments, a program as above which may be written in any conventional programming language, and optionally a machine for executing the program such as but not limited to a general purpose computer which may optionally be configured or activated in accordance with the teachings of some embodiments. Any of the teachings incorporated herein may wherever suitable operate on signals representative of physical objects or substances.

The embodiments referred to above, and other embodiments, are described in detail in the next section.

Any trademark occurring in the text or drawings is the property of its owner and occurs herein merely to explain or illustrate one example of how an embodiment may be implemented.

Unless specifically stated otherwise, as apparent from the following discussions, it is appreciated that throughout the specification discussions, utilizing terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining” or the like, refer to the action and/or processes of at least one computer/s or computing system/s, or processor/s or similar electronic computing device/s, that manipulate and/or transform data represented as physical, such as electronic, quantities within the computing system's registers and/or memories, into other data similarly represented as physical quantities within the computing system's memories, registers or other such information storage, transmission or display devices. The term “computer” should be broadly construed to cover any kind of electronic device with data processing capabilities, including, by way of non-limiting example, personal computers, servers, embedded cores, computing system, communication devices, processors (e.g. digital signal processor (DSP), microcontrollers, field programmable gate array (FPGA), application specific integrated circuit (ASIC), etc.) and other electronic computing devices.

Some embodiments may be described, merely for clarity, in terms of terminology specific to particular programming languages, operating systems, browsers, system versions, individual products, and the like. It will be appreciated that this terminology is intended to convey general principles of operation clearly and briefly, by way of example, and is not intended to limit the scope of some embodiments to any particular programming language, operating system, browser, system version, or individual product.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectable e.g. a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate information as described herein and/or to perform functionalities described herein and/or to implement any engine, interface or other system described herein. Any suitable computerized data storage e.g. computer memory may be used to store information received by or generated by the systems shown and described herein. Functionalities shown and described herein may be divided between a server computer and a plurality of client computers. These or any other computerized components shown and described herein may communicate between themselves via a suitable computer network.

The following terms should be expansively construed to either consist of the following or include at least the following or to consist of or include definitions thereof which are known in the art:

Dataset: may include an identifiable collection of structured data objects unified by some criteria (authorship, subject, scope, spatial, or temporal extent . . . ).

Host: set of servers that respond to requests sent via network protocols to a specific domain name. In Internet protocol specifications, the term “host” means any computer that has full two-way access to other computers on the Internet. A host typically has a specific “local or host number” that, together with the network number, forms its unique IP address. If an end-user uses Point-to-Point Protocol to get access to her or his access provider, she or he has a unique IP address for the duration of any Internet connection she or he makes and her or his computer is a host for that period. In this context, a “host” is a node in a network. More generally, any set of servers that respond to HTTP (say) requests. Load balancing, any cast, and many other conventional techniques allow multiple servers to act as a single “host”.

Metadata: intended to include any data that describes other data. For example, a title, or author, or publication date of a particular data component e.g. text document that can be downloaded as a unit. The term “Metadata” is intended to include structured information that describes, explains, locates, or otherwise makes it easier to retrieve, use, or manage an information resource (e.g. NISO 2004, ISBN: 1-880124-62-9). Making metadata machine-readable increases its utility but requires standardization, defining not only field names, but also how information is encoded in the metadata fields. US Government Agencies are required to describe information using common core metadata, in consultation with practices in Project Open Data. Metadata should include information about origin, linked data, geographic location, time series continuations, data quality, and indices that reveal relationships between datasets and allow determining the context, freshness and quality of the data source. Agencies may expand upon the basic common metadata based on standards, specifications, or formats developed within different communities (e.g., financial, health, geospatial, law enforcement). The common core metadata may be based on DCAT, or any other suitable hierarchical vocabulary specific to datasets. Agencies generating information must use machine-readable and open formats, data standards, and common core and extensible metadata for information creation and collection. Information stewardship is ensured through the use of open licenses and review of information for privacy, confidentiality, security, or other restrictions to release. Agencies building or modernizing information systems must maximize interoperability and information accessibility, maintain internal and external data asset inventories, and enhance information safeguards.

Public: e.g. available to the public e.g. via Internet, as opposed to data serving only end users within an organization. Sometimes, a listing indicating, “we have this data” is public but the data itself is not. The public nature of a specific dataset is an important feature of an open data dataset, for some applications.

Publication: content e.g. components, plus a collection or set of metadata characterizing aspects of that content, either or both of which may change over time, both (typically) of which are accessible electronically responsive to activation of a URL (one or more) by end users. This URL aka “the publication's URL” is said to be “associated with” the publication. It turns out that, sometimes, publication with content is published on the web by an agency official. For example, an official from the U.S. federal Department of State (DoS) may list as a publication in DoS' data.json catalog information about a dataset that contains a list of embassies but without actually publishing the data itself

Links are URLs contained within a publication. If there are zero links, the content itself is not publicly accessible via that catalog. Example: building codes, typically listed in open data catalogs, but if an end-user wants a copy of the codes, the end-user is required to fulfill certain conditions e.g. payment, to obtain a copy of the code. A URL embedded in a catalog when activated by an end user who has accessed the catalog electronically, is intended to, and typically although not always does, leads the user to a publication with which the URL is associated e.g. leads to the data described by the publication's metadata. In practice, publications not infrequently are found to include broken links. Typically, the system records existence of these.

External links: for example, if nasa.gov is being crawled, jpl.nasa.gov and whitehouse.gov are external links.

Catalog: intended to include any software system that runs on a host, is accessible electronically to end users via network protocols such as but not limited to HTTP/S and includes plural URLs which when activated by the end user, lead the user to respective plural publications. Or, a listing of data sets e.g. that which holds all open data publications generated by American federal departments and agencies (e.g. at https://www.data.gov/) namely the following catalog: http://catalog.data.gov/dataset. A catalog, in the US Government's vision, is a collection of descriptions of datasets; each description is a metadata record. The intention of a data catalog is to facilitate data access by users who are first interested in a particular kind of data, and upon finding a fit-for-purpose dataset, will next want to know how to get the data. The catalog file for each agency should list all of the agency's datasets that can be made public, whether by a file download or through a Web API. A Web API (Application Programming Interface) allows computer programs to dynamically query a dataset using the World Wide Web. For example, a dataset of farmers markets may be made available to developers through a Web API, such that a computer program could use a ZIP Code to retrieve a list of farmers markets in the ZIP Code area.

Typically, the code of the system herein does not ‘read’ the html pages but rather reads a source catalog, which may also be rendered in an html view for end-users. Catalogs need not be of the ckan type. For example, the US Federal Agency Catalog is a catalog of type “data.json v1.1” of the Centers for Medicare and Medicaid (CMS). The code herein, according to some embodiments, may discover this catalog and ‘unpack’ the catalog to publications. End-users may view different types of html views or search tools that explore this catalog. An example of a catalog of type “ckan3” is that of the City of Hamburg. Catalogs are often associated with entities at various levels e.g. levels of municipal agency, municipality, regional agency, region, state agency, state/territory, national/federal agency, national/federal, international agency, and international organization.

A catalog may include a public data listing of datasets in an agency's enterprise data inventory. For example, US government agencies are required to “update their inventory of agency information resources (as required by OMB Circular A-130) 24 to include an enterprise data inventory, if it does not already exist, that accounts for datasets used in the agency's information systems. The inventory will be built out over time, with the ultimate goal of including all agency datasets, to the extent practicable. The inventory will indicate, as appropriate, if the agency has determined that the individual datasets may be made publicly available (i.e., release is permitted by law, subject to all privacy, confidentiality, security, and other valid requirements) and whether they are currently available to the public. The Senior Agency Official for Records Management should be consulted on integration with the records management process. Agencies should use the Data Reference Model from the Federal Enterprise Architecture 25 to help create and maintain their inventory. Agencies must describe datasets within the inventory using the common core and “extensible metadata”.

Any datasets in a US government agency's enterprise data inventory is required to be made publicly available “must be listed at www.[agency].gov/data in a human- and machine-readable format that enables automatic aggregation by Data.gov and other services (known as “harvestable files”), to the extent practicable. This should include datasets that can be made publicly available but have not yet been released. This public data listing should also include, to the extent permitted by law and existing terms and conditions, datasets that were produced through agency-funded grants, contracts, and cooperative agreements (excluding any data submitted primarily for the purpose of contract monitoring and administration), and, where feasible, be accompanied by standard citation information, preferably in the form of a persistent identifier. The public data listing will be built out over time, with the ultimate goal of including all agency datasets that can be made publicly available. See Project Open Data for best practices, tools, and schema to implement the public data listing and harvestable files.

Entity (aka publishing entity—such as government agencies such as NASA, municipalities, international organizations: A computerized organization that controls a catalog hence effectively publishes (and optionally manages/modified) a multiplicity of publications via one or more catalogs. Management may for example proceed in accordance with the USA Office of Management and Budget (OMB) Memorandum M-13-13 (May 9, 2013) titled “Open Data Policy—Managing Information as an Asset”, or any other systematic procedure.

Information asset: Intended to include a single publication not known to have duplicates, or a set of duplicate publications managed by a single publishing entity. An Information Asset can also be any collection of related e.g. duplicate datasets that is assembled, linked e.g. as described herein, described e.g. as described herein, and managed e.g. modified, by an organization or individual (e.g. publishing entity). An information asset is typically managed as a single entity throughout its life cycle. “Agencies” (governmental entities which generate or control data repositories) are sometimes required to manage their information as an asset throughout its life cycle e.g. by complying with Executive Order of May 9, 2013, Making Open and Machine Readable the New Default for Government Information.

Component: actual content of data described by the publication metadata. Typically includes a file (say, a Word or excel file) that an end user can download.

A component is typically content that is downloaded as a unit. So, if 2 related files are available for download separately, then each may be considered a separate component. A single component may contain parts or entire other components (so end user can download each page separately, or as one pdf, e.g.).

Typically, each Component includes the contents of but a single computer file. Typically, that file's name is stored separately from the content. Typically, the name of the file from within which a component has been downloaded may be obtained via the last path segment in the URL, and/or from the relevant HTTP header and/or, for some files, from zip archives e.g. docx files. The term Component is intended to include any data file e.g. text file or body of data, which is described by metadata, hence can be regarded as including raw information, at least relative to the metadata describing it. It is appreciated that a publication's metadata might include zero to many components. For example, the public official who uploaded open data may have provided metadata about the publication but may have failed to upload the publication's data itself (zero components). One component—A scenario found to be relatively common is that an entire publication's metadata describes a single EXCEL/CSV file that holds data. Other files (like license) are not provided at al. Many components—Another scenario found to be relatively common is that the publication's metadata describes many files. So, for example, ten excel files, one dictionary file, and another metadata file are—together—a publication that describes the condition of the soil in a particular region in a certain period. Often, each publication includes a component, plus metadata describing that component. However, while ideally, a publication should include at least one component, the system herein is typically operative to register metadata for publications even if the system fails to discover or find even a single component (Zero Components) because the system according to some embodiments makes use of its limited knowledge at the metadata-publication even if the actual data (components) corresponding to the metadata are absent e.g. because a publisher purports to publish data but does not actually do so.

Metadata, catalog level—intended to include any metadata describing attributes of a catalog as a whole e.g. the organization that owns the catalog, the date on which the catalog became first available on the web, the language of the catalog.

Metadata, publication level—intended to include any metadata describing attributes of a publication as a whole e.g. the spatial and temportal boundaries of the publication, the author who uploaded the publication to the web, and keywords that jointly define the entire publication.

Metadata, component level—intended to include any metadata describing attributes of a component as a whole e.g. type (non-file, class file, csv file etc.), size in bytes, and language of component.

Entity Aka Named entity: in the context of text analysis—a proper noun in a natural language (e.g. English) sentence structure, such as Colorado State, the US Department of Energy, or Joshua Norton.

Crawling: since catalogs' publications change over time. Crawling of catalogs is performed on occasion e.g. periodically, to ascertain a current state of each catalog, e.g. in accordance with flow1 e.g. as per FIGS. 6a-6b. A catalog may be crawled periodically and multiple times in order to ensure that the Metadata (at the publication level and component level) is timely, accurate, and comprehensive.

Download: When the drawler process herein requests a URL from the server described by the URL, this event is termed a download and is recorded e.g. each download may be a record in a “downloads” fact table. The content downloaded may be recorded, in that record e.g., as a component. However, some components may have no downloads. For example a component including a file inside a zip file may never have been downloaded. Components may be referred to e.g. uniquely identified by their message digest such as but not limited to SHA1 or SHA2, MDS, any other suitable cryptographic digest function, or any other suitable hash function.

open data: e.g. as in the US government's “project open data”. Open data may be required to comply with, but in practice only sometimes and/or only partly complies with, some or all of the following:
1. Collect or create information in a way that supports downstream information processing and dissemination activities—typically
a. Use machine-readable and open formats
b. Use data standards
c. Ensure information stewardship through the use of open licenses
d. Use common core and extensible metadata
   2. Build information systems to support interoperability and information accessibility
   3. Strengthen data management and release practices
a. Create and maintain an enterprise data inventory
b. Create and maintain a public data listing
c. Create a process to engage with customers to help facilitate and prioritize data release
d. Clarify roles and responsibilities for promoting efficient and effective data release practices
   4. Strengthen measures to ensure that privacy and confidentiality are fully protected and that data are properly secured
   5. Incorporate new interoperability and openness requirements into core agency processes

Staging: set of tools, physical storage space, workflows, and procedures that are used for data processing e.g. to process aka ‘cook’ data preparatory to its final presentation to an end-user. E.g. find some initial metadata on the web about a publication and its components. Store in a physical staging area in computer memory. Improve/correct/add/remove/unify (from different catalogs) the metadata about this publication—AKA performing staging activities. When publication's metadata reaches a certain level of completeness, accuracy, and enrichment—move the publication's metadata to the production area to provide browsing availability to end users or clients.

### BRIEF DESCRIPTION OF THE FIGURES

Some embodiments are illustrated in the following figures:

FIG. 1 is an example functional block diagram of a system in accordance with an embodiment.

FIGS. 2a-2b, 3a-3b are example high-level workflows.

FIGS. 4, 5a-5b are illustrator tables useful in understanding some embodiments herein.

FIGS. 6a-6b, 9 taken together are a simplified flowchart illustration of a method for Component crawling (aka flow1), variations of which are described herein. This may for example be performed by the crawling system of FIG. 1.

FIGS. 7, 8 taken together are a simplified flowchart illustration of a method for relationship discovery (aka flow2), variations of which are described herein, operative for detecting relationships between publications included in at least one catalog, and de-duping accordingly. This may for example be performed by the staging system of FIG. 1.

Methods and systems included in the scope of some embodiments may include some (e.g. any suitable subset) or all of the functional blocks shown in the specifically illustrated implementations by way of example, in any suitable order e.g. as shown.

Computational, functional or logical components described and illustrated herein can be implemented in various forms, for example, as hardware circuits such as but not limited to custom VLSI circuits or gate arrays or programmable hardware devices such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines and programs and may originate from several computer files which typically operate synergistically.

Each functionality or method herein may be implemented in software, firmware, hardware or any combination thereof. Functionality or operations stipulated as being software-implemented may alternatively be wholly or fully implemented by an equivalent hardware or firmware module and vice-versa. Any logical functionality described herein may be implemented as a real time application if and as appropriate and which may employ any suitable architectural option such as but not limited to FPGA, ASIC or DSP or any suitable combination thereof.

Any hardware component mentioned herein may in fact include either one or more hardware devices e.g. chip/s, which may be co-located or remote from one another.

Any method described herein is intended to include within the scope of the embodiments also any software or computer program performing some or all of the method's operations, including a mobile application, platform or operating system e.g. as stored in a medium, as well as combining the computer program with a hardware device to perform some or all of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary or off-line; which is of any type or level or amount or category of volatility, differentiation, mutability, accessibility, addressability, capacity, performance and energy use; and which is based on any suitable technologies such as semiconductor, magnetic, optical, paper and others.

### DETAILED DESCRIPTION OF EXEMPLARY EMBODIMENTS

Some embodiments of the presently disclosed subject matter are described below:

Unless specifically stated otherwise, as apparent from the following discussions, it is appreciated that throughout the specification discussions utilizing terms such as “processing”, “computing”, “crawling”, “comparing”, “generating”, “assessing”, “matching”, “updating” or the like, refer to the action(s) and/or process(es) of a computer that manipulate and/or transform data into other data, the data represented as physical, such as electronic, quantities and/or the data representing the physical objects. The term “computer” should be expansively construed to cover any kind of electronic device with data processing capabilities including, by way of non-limiting example, computer-based crawler disclosed in the present application.

It is to be understood that the term “non-transitory memory” is used herein to exclude transitory, propagating signals, but to include, otherwise, any volatile or non-volatile computer memory technology suitable to the presently disclosed subject matter.

It is also to be understood that the term “signal” used herein excludes transitory propagating signals, but includes any other signal suitable to the presently disclosed subject matter.

The operations in accordance with the teachings herein may be performed by a computer specially constructed for the desired purposes or by a general-purpose computer specially configured for the desired purpose by a computer program stored in a computer readable storage medium.

The term “Catalog” used in this patent specification should be expansively construed to cover any kind of system that lists multiple publications.

The term “Publication” used in this patent specification should be expansively construed to cover any kind of a collection of metadata indicative of the existence of a set of documents. By way of non-limiting example, the US Department of State can publish metadata related to a list of US embassies, including exact addresses, etc. While the information itself is not public, the related metadata is publicly available.

The term “Component” used in this patent specification should be expansively construed to cover any kind of a single content item described by a publication.

The term “Information Asset” used in this patent specification should be expansively construed to cover any kind of collection of related data that is assembled, linked, described, and managed by an organization or individual. An information asset is managed as a single entity throughout its life cycle as specified, for example, by the USA Office of Management and Budget (OMB) Memorandum M-13-13 (May 9, 2013) titled “Open Data Policy—Managing Information as an Asset”.

Embodiments of the presently disclosed subject matter are not described with reference to any particular programming language. It will be appreciated that a variety of programming languages may be used to implement the teachings of the presently disclosed subject matter as described herein.

As will be appreciated by one of ordinary skill in the art, aspects of some embodiments may be embodied as a system, method, or computer program product. Accordingly, aspects of some embodiments may take the form of an entirely hardware embodiment, an entirely software embodiment (including firmware, resident software, micro-code, etc.) or an embodiment combining software and hardware aspects that may all generally be referred to herein as a “circuit, “module” or “system”. Furthermore, aspects of some embodiments may take the form of a computer program product embodied in any computer readable medium having computer usable program code embodied thereon.

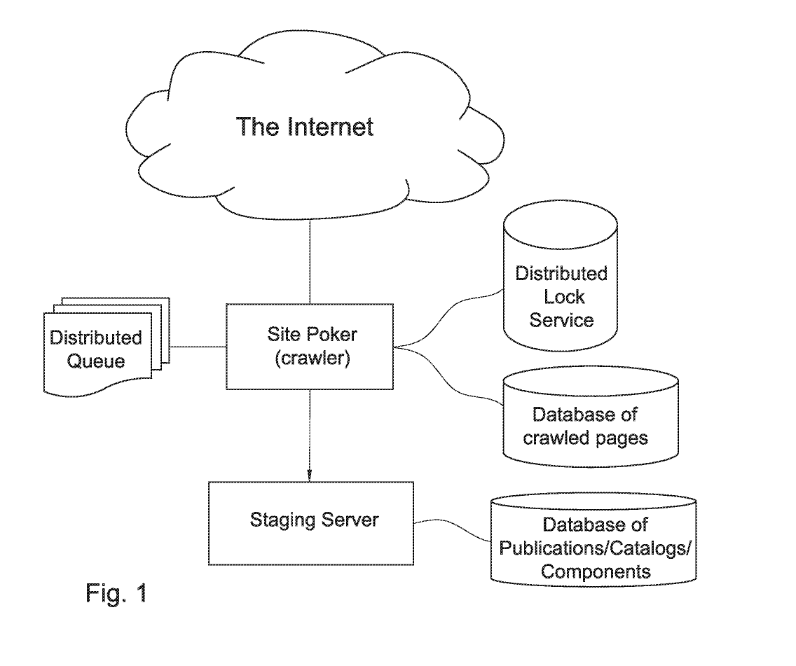

Bearing this in mind, attention is drawn to FIG. 1 illustrating a generalized network environment including a crawling system (poker) configured in accordance with some embodiments of the presently disclosed subject matter.

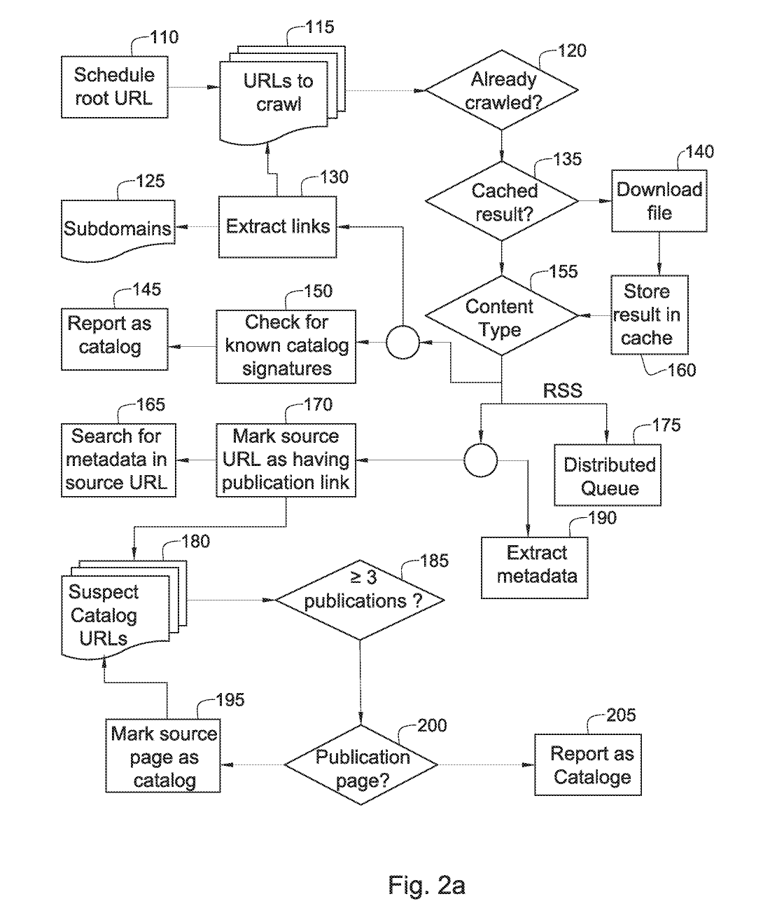

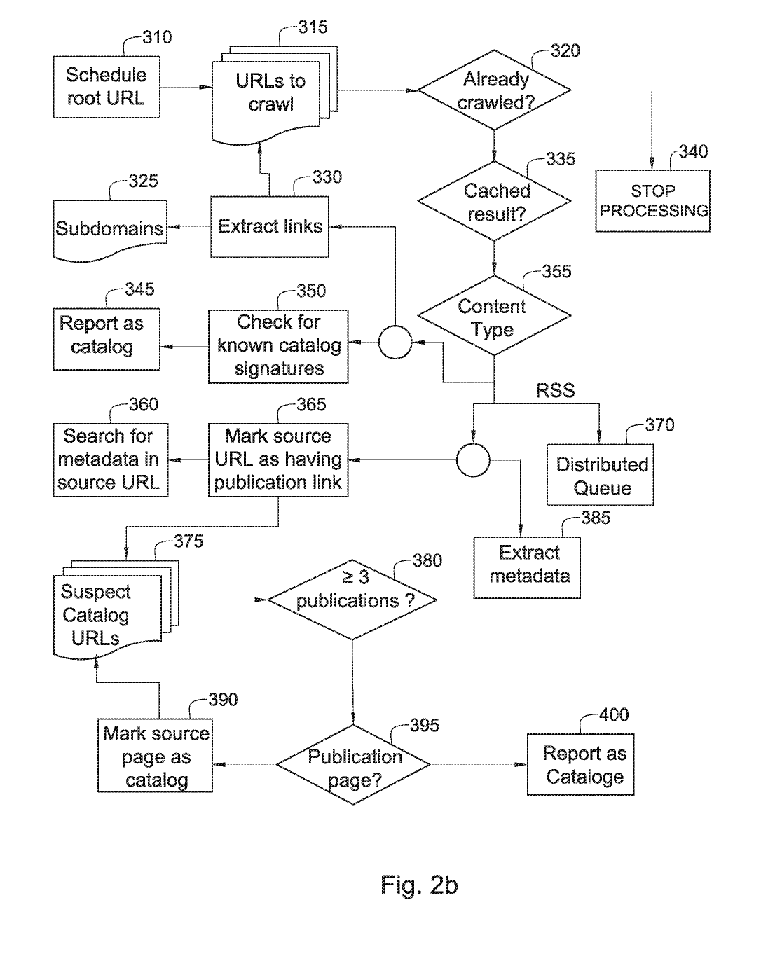

Referring to FIG. 2, there is illustrated a generalized flow chart of a site poking process. In accordance with some embodiments of the presently presented subject matter, the site poking is the process-enabling discovery of which catalogs are running on a host. It receives as its input a domain name, such as, for example, “nasa.gov”. It outputs a list of information catalog systems and their locations within that system running on the server. It does this by examining multiple data available from the server, such as HTTP headers, HTML documents, etc. The process can also produce a list of additional servers to investigate, such that all of them are sub-domains (“jpl.nasa.gov”, for example, but not “noaa.gov”).

First, the poker starts by crawling all the HTML assets of the server, akin to a standard web crawler. Based on HTML tags that declare the presence of standard catalog software, the poker reports the existence of these catalogs. Next, the poker follows all links on the page, and takes actions based on the type of link and/or the type of content served by the link, for example:

“External link to a subdomain”—the subdomain is added to the set of subdomains to be

“poked” later, however the link is not followed;

HTML formats—scheduled for crawling as above;

RSS formats—reported as a catalog;

Other formats—reported as a component, and the owning page as a potential catalog.

If a page contains a predefined number (e.g. 3 or more) publication links, it is marked as a “generic” catalog. The poker then applies metadata extraction that searches for several sources of metadata: for example, RDF tags, other standard formats of linked metadata, etc. If no metadata is found, it traverses the DOM of the HTML to find a common unit of analysis in the page such that it appears that the content is describing one link exactly. If no such common unit of analysis can be found, then the page is considered as a page describing a single publication. In the case that there are more than a predefined number of pages (e.g. 3 pages) describing a single publication, then the poker searches for pages that link to a plurality of publications and mark those pages as “catalog” pages. Optionally, the poker can search the site using a model (e.g. NLP and/or RNN model) that is trained against the site as a whole to find the relevant metadata fields. The heuristic models used here may be “trained” by a human operator to better recognize catalog systems.

Next, the poker detects metadata markers, such as, for example, HTTP headers to assist in determining if a server is running well known catalog software. CKAN, for example, sets the “X-CKAN-API-KEY” header by default.

Finally, the poker attempts to retrieve content from well-known locations of catalog software within a system (also termed herein “well known URL patterns), such as “/data.json”, “/sitemap.xml”, etc. If these attempts are successful, then these catalogs are reported as well.

Before the list of discovered catalogs is output, an additional phase checks for duplicate catalogs. Meaning that if a single catalog system provides multiple methods of accessing its contents, such as via a “data.json” file and a CKAN API, then the poker only reports one, according to which provides more metadata in a more structured manner.

When running the poker in aggregate mode, meaning that it consumes all subdomains as well, the poker will also compare catalogs to each other, to determine if detected catalogs are duplicates of each other under different names (for example, data.example.com and opendata.example.com). The poker will also take random samples of publications and attempt to compare them to each other.

In addition to discovering catalogs on the server, the poker will also compare the results according to the history of the same site, and will report changes in the catalog makeup of the system, such as removed catalogs or changing versions. In the case that a catalog is producing errors, such as JSON syntax errors in a data.json catalog, or API errors in the case of CKAN, SODA, or Junar, this information is included in the report.

Bearing this in mind, attention is drawn to FIG. 1 illustrating a generalized network environment including a staging system configured in accordance with some embodiments of the presently disclosed subject matter. The staging system further includes a link categorization engine configured to enable operations further detailed with reference to FIG. 2. It is noted that while some of the input data can be pulled from a crawler, the link categorization engine works off information gathered in the staging system database.

Referring to FIG. 2, there is illustrated a generalized flow chart of detecting related web content items. In accordance with some embodiments of the presently presented subject matter, the process includes automatically discovering relationships between publications. The relationships, which are discovered, include temporal, geographical, categorical (e.g. corn production vs. potato production), duplicate, subset (where one publication contains another), aggregation, collation, translation, and mirroring (where identical publications are hosted on multiple servers).

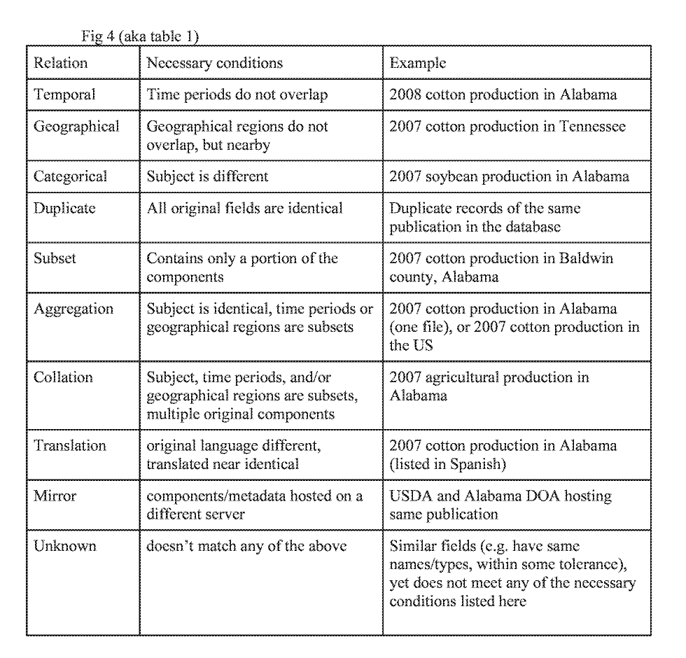

The exemplified relationship between publications is illustrated in FIG. 4.

When crawling a catalog, the crawler stores all the metadata discovered regarding the publication, and attempts to download the underlying data and extract further metadata. In the case of tabular data, the crawler can extract the number of rows, names and types of columns, and statistical markers of the data (e.g. mean, median, variance, minimum, and maximum for numerical data, mode for categorical data, etc.). For document data, the crawler can extract the authorship information, extract any tables embedded within the document, document length (pages, lines, words), reading level, estimated reading times, etc.

After the metadata has been stored, it is scheduled for advanced extraction. Optionally, the publication metadata can be translated into English by an external service. The crawler further extracts additional metadata fields, such as, for example, applicable time periods and geographical regions from the textual fields such as title, description, URL paths, etc. This can be done using named entity extraction as part of commonly available NLP (natural language processing) libraries.

Upon receipt of the metadata from the crawler, the staging system schedules a “relationship discovery process”. The operation starts by producing a list of “potential” publications, which may have some relationship to the current one. This is based on shared links as part of the publication, similarity in title and other textual fields (after translation), and comparison of digests and schemas of the actual data.

When comparing each publication, the relationship discovery engine examines available metadata to determine the nature of the relationship between the publications. The types of relationships are described above. Such relationships are tagged with additional metadata, such as the proportion of duplication, which revision of the metadata they apply to, etc.

User behavior of subsequent searches and viewing different publications for download/purchase is also marked as creating a relationship between publications. Specific information that is known about a user may be used to consider that link as being stronger or weaker (for example, if someone downloads every publication they come across, then the links they create would be weaker as compared to a user who works in the sewage department and downloads a small number of publications).

The relationship discovery engine marks the relationship data produced here for future processes to determine if a set of publications represents one or more information assets, which is the fundamental unit of our search engine (i.e., one information asset is one search result).

It is noted that, when a change is detected in the metadata of a publication, then the metadata revision is incremented, text fields retranslated if changed, and the entire process run again.

It is noted that the teachings of the presently disclosed subject matter are not bound by the network environment and the crawler described with reference to the drawings. Equivalent and/or modified functionality can be consolidated or divided in another manner and can be implemented in any appropriate combination of software, firmware and hardware and executed on a suitable device. The crawler can be a standalone network entity, or integrated, fully or partly, with other network entities. Those of ordinary skill in the art will also readily appreciate that the data repositories can be consolidated or divided in other manner; databases can be shared with other systems or be provided by other systems, including third party equipment.

It is noted that the teachings of the presently disclosed subject matter are not bound by the flow charts illustrated, the illustrated operations can occur out of the illustrated order. For example,

Searching for metadata in the source URL and marking the source URL as having a publication link as shown in succession can be executed substantially concurrently or in the reverse order.

For example, operations “Named entity extraction” and “Download components” shown in succession can be executed substantially concurrently or in the reverse order.

It is to be understood that some embodiments are not limited in their application to the details set forth in the description contained herein or illustrated in the drawings. Some embodiments are capable of other embodiments and of being practiced and carried out in various ways. Hence, it is to be understood that the phraseology and terminology employed herein are for the purpose of description and should not be regarded as limiting. As such, those of ordinary skill in the art will appreciate that the conception upon which this disclosure is based may readily be utilized as a basis for designing other structures, methods, and systems for carrying out the several purposes of the presently disclosed subject matter.

It will also be understood that the system according to some embodiments may be, at least partly, a suitably programmed computer. Likewise, some embodiments contemplate a computer program being readable by a computer for executing the method of some embodiments. Some embodiments further contemplate a machine-readable memory tangibly embodying a program of instructions executable by the machine for executing the method of some embodiments.

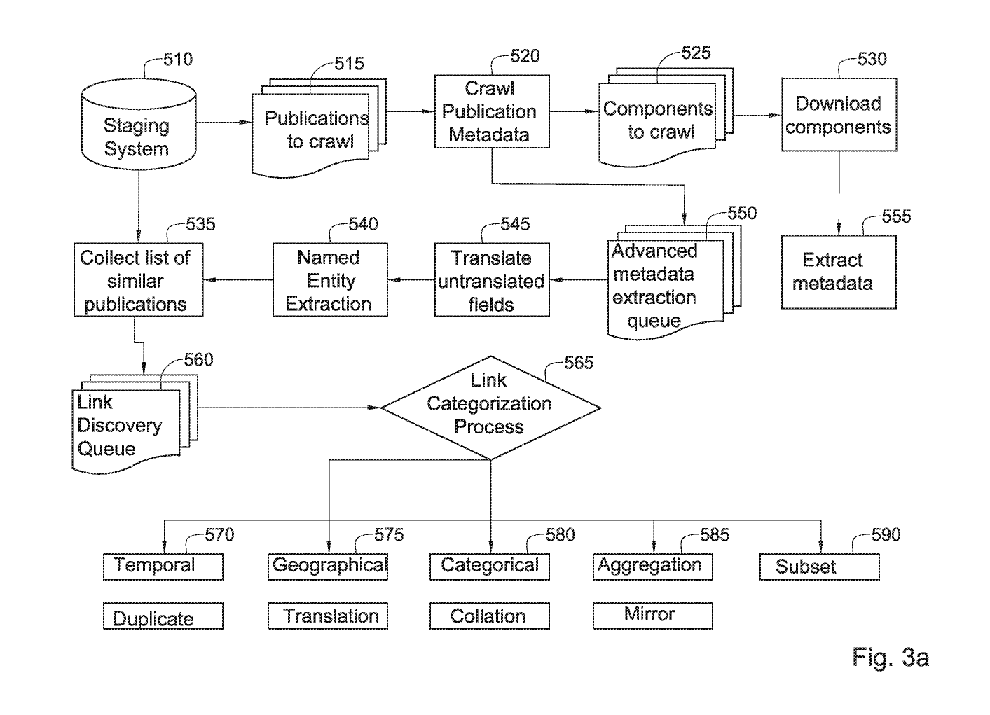

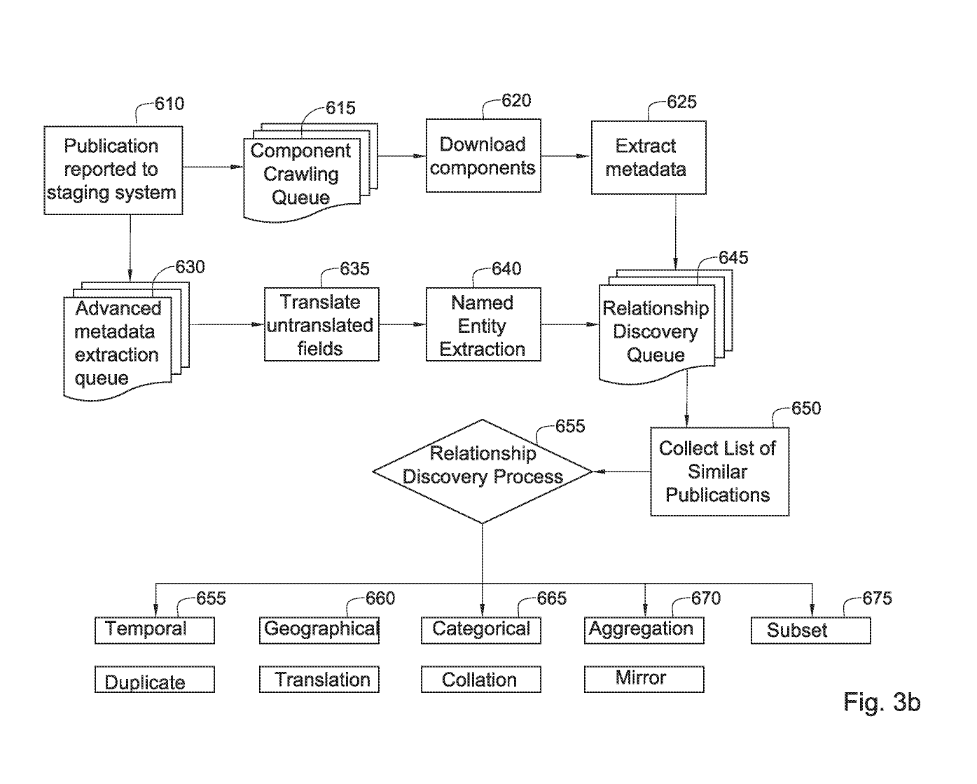

More generally, FIG. 1 illustrates a staging system, which includes a relationship discovery engine configured to enable a related web content item detection flow of FIG. 2a or 2b wherein relationships between publications are automatically discovered. An example of related publications is illustrated in Table 1 below. While some of the input data can be pulled from a crawler e.g. from the poker aka crawler of FIG. 1 (e.g. operations 2510-2530 below), the relationship discovery engine/process of FIG. 3a or 3b also works (e.g. operation 2540 onward, below) off information gathered in the staging system database which stores tables inter alia as described herein in detail.

The staging server in FIG. 1 may be similar to the staging system in FIGS. 3a, 3b. The staging system may expose an API that is accessed via http, and the system may interact directly with the staging database. Other systems may not interact with the staging database, only with the API. For simplicity, FIG. 1 is shown with a single crawler but this may for example include a single crawler process with logically separated code. This may be run as a cluster, typically all talking to the same database, queue, redis. The distributed queue in FIG. 1 typically includes a queue of tasks to be run by the crawlers. Several servers may manage the queue (distributed management), and several servers may perform the tasks. The system of FIG. 1 typically includes at least one data repository e.g. 2 databases as shown. The first is for crawled pages e.g. for bookkeeping while crawling, and the second database includes a publications/catalogs/components database aka “the staging database”.

The flow of FIG. 2a or 2b may be performed by the site poker of FIG. 1. “Content type” in FIG. 2a or 2b may include an optional response header that defines how the system, in its capacity as an http client should process the response; including a hint as to what file type the response is (html, json, PDF, docx). This, in practice, is not always set, and when set, is sometimes set incorrectly. In FIG. 2—“result” includes the result of downloading the URL e.g. the http response body.

In FIG. 2a, “mark source page as catalog” block 195 and its counterpart in FIG. 2b, may use the staging API, since the crawler code lives elsewhere. The staging system stores may store this in the catalogs table.

The flow of FIG. 3a or 3b may be performed by the staging server of FIG. 1. FIG. 3 typically includes a relationship discovery queue and an advanced metadata extraction queue. Each type of task is typically managed in a separate queue by the distributed queue and all are typically managed by the same distributed queue cluster. According to one embodiment, a single task queue and a single worker process are provided. The queue need not be exactly as described herein. Any other suitable source for each queued item may be employed; items may arrive on the queue at frequencies other than those described herein and may be allowed to wait more or less than described herein; items may or may not be allowed to jump ahead in the queue, multiple queues may or may not be formed and managed, and any suitable rules by which items are enqueued and dequeued may be employed. Items may be handled using any suitable scheme e.g. LIFO or FIFO. IBM's Distributed queue management (DQM) technology may be used to define and/or control communication between queue managers including some or all of: defining and controlling communication channels between queue managers, Providing a message channel service to move messages from a local queue, e.g. transmission queue, to communication links on a local system, and from communication links to local queues at a destination queue manager, and/or providing facilities for monitoring operation of channels and diagnosing problems, e.g. using panels, commands, and/or programs.

Tables that may be loaded into memory and/or retrieved from memory and utilized in the flows herein, and may for example be stored in the databases of FIG. 1, are now described. Any suitable subset of the tables described herein, and any suitable subset of the fields in each table may of course be provided, and augmented if and as desired with additional fields and tables. For example, the ‘publication’ FACT table or ‘component’ table (or any other) may include literally any subset of the fields actually shown herein e.g. each field shown herein may either be provided or not, depending on the demands of a particular situation on the system.

The terms “fact table” and “dimension table” are terms in dimensional modeling of enterprise data warehouses. The term FACT table is intended to include a table in a relational database (e.g. a table that contains columns and rows where the columns are the table-fields and each row contains a different real-life instance of the content that the table is modeling). FACT tables typically contain data that is transactional in nature e.g. whatever the poker described herein finds when the poker crawls the Internet for open data such as catalogs, components, and downloads. FACT tables might contain trillions of rows.

Each row of each fact table typically includes a description of a specific entity or interaction of the system. For example, the ‘publication’ FACT table stores metadata (some harvested from the web and other created by the system) about a specific information asset.

The term DIMENSION table is also intended to include a table in a relational database e.g. used to support queries about FACT tables. DIMENSION tables tend to be much smaller than FACT table and facilitate asking about an domain or context that the relational database is modeling, e.g. using conventional domain modeling or domain-specific modeling techniques. A domain model may for example be implemented as an object model within a layer that uses a lower-level 1 layer for persistence and “publishes” an API to a higher-level layer to gain access to the model's data and/or behavior. A single DIMENSION table, its structure, and contents can support multiple databases in multiple domains.

### Example

combining information from a small dimension table to data in a much bigger FACT tables to answer an END USER QUERY such as: “How many open data publications exist on the Internet for Russia?”

To answer this query, the system may join data from the FACT table ‘publication’ with one row in the DIM_COUNTRY dimension table (e,g the row about Russia). Due to the dimensional model information about Russia need be added only in a single row in a single table (e,g, the DIM_COUNTRY) thereby to facilitate queries like “How many open data publications exist for countries that have, each, more than 100 million citizens and residents?”

To answer this, register only in one place (e.g. the Russia row in the DIM_COUNTRY dimension table, in the ‘population’ column aka field) how many people live in Russia. When the relational engine receives the above query, the engine finds in the DIM_COUNTRY dimension tables all rows for all countries where more than 100 million people live, join to the publication table, and output a total count of all publications for all these countries.

The crawler of FIG. 1 may store only data to speed up future runs such that even if the entire crawler database is deleted, the entire system of FIG. 1 is able to work normally The crawler of FIG. 1 may store only technical data such as etags, crawling timestamps, digests and data pertaining to last (e.g. most recent) error messages.

Typically, the crawler of FIG. 1 stores one catalog table and one publication table for each catalog type (CKAN, data.json, etc.), e.g. as follows (where xxx may be replaced by the catalog type, such as ckan_catalog, datajson_catalog, etc.):

xxx_catalog
url
etag (may be used for efficient HTTP requests, e.g. as per RFC 2616 section 13.3.2)
last_crawl
last_change
last_error

xxx_publication
index_id (used as a weak identifier, and speeds things up a little bit)
blob_hash (a message digest of the raw response about the publication, used to avoid reporting a duplicate publication to the staging system)

Optionally, the above tables somewhat vary between various catalog types (CKAN, data.json, etc).

The tables in the staging system database may include inter alia, some or all of the following:
Fact tables: publications, links, downloads/download_hops
Dimension tables: catalogs, url, component.

So for example, in this example embodiment, whereas the above xxx_catalog and xxx_publication tables typically reside in the crawler, the following catalogs and publications tables typically reside in the staging db. The fields in each of the tables in the staging system database may include inter alia, some or all of the following:

Catalogs
suspected_url—e.g. start the crawling process from here
catalog_type—e.g. either NULL, or one of CKAN2, CKAN3, data.json, data.json11, rss, html
base_url—this may only be assigned once system has determined that it's an actual catalog, and that the system has a compatible crawler for that catalog
name—
credentials—if access to the catalog is restricted, these credentials may be used to access that catalog. For example, Bahrain publishes open GIS data through a publicly open ArcGIS server, and publishes the username and password to access the open GIS data freely.

Surrogate keys (id fields), and physical timestamps (created_at, updated_at) may be provided here and for most tables.

Publications
catalog_id
crawled_at
uploaded_at—some catalogs expose this as a separate field, since it may be data that was republished elsewhere, or on a newer catalog system.

All the metadata that the system gathers; e.g. Dublin Core or similar with extensions for open government data. The data.json spec for example has a suitable list, some or all of which may be provided.

Translated metadata fields—some or all of: title, description, category, keywords may be machine-translated e.g. via Google Translate

Links
publication_id
url_id
label—e.g. most catalogs include a label for the link

urls
url—e.g. literally just the text of the URL

downloads
url_id
component_id
filename
downloaded_at
status_code
content_type
likely_broken_link—e.g. Yes/No flag set if the status code was 400-499, or if the content included a few key phrases, since many broken links that give a 200 OK then serve HTML that says “page not found”.
download_hops—because HTTP can “redirect” requests elsewhere, it can occur that a single request is really a chain of 7.
download_id
url_id
started_at
hop_number
status_code

components
digest
size
file_type—this is detected using, say, “magic” as a software tool, and “mimemagic” as Ruby bindings.

Suitable tables may be provided for tracking different file types such as tabular data and file archives e.g. some or all of:

subcomponents
parent_id
subcomponent_id
filename

tabulars
component_id
rows
name

fields
tabular_id
name
datatype
min
max
mean
mode
stddev

The above may each include surrogate keys and physical timestamps (e.g. id, created_at, updated_at).

Other tables may be provided to track intermediate progress in the crawlers, and redis may be used as a key value store to implement a lock manager (so the system only requests data from a site at reasonable intervals e.g. once every 10 seconds at the most). redis is a key-value database that offers a feature that can be used to turn it into a locking manager e.g. by passing out a “token” that reserves a domain name. A mapping of domain names to the next time the system is to send a request to a specific domain name, may be stored. Typically, a crawler which starts downloading, gets this token from redis, checks if the system can send a request to that domain name, and hands back the token to redis if not, putting the URL back in the queue and moving on to the next URL in the queue. If requesting from the site is “okay”, the URL is downloaded. When the crawler has finished downloading but before processing begins, the system may set the next request for the domain name to now+(say) 10 seconds (a parameter which may be set in their robots.txt), and pass the token back to redis. This prevents overload on servers that are shared with others.

It is appreciated that the set of FACT tables and fields above are in no way intended to limit the tables or fields that may be provided in the staging database OF FIG. 1. They are merely one example implementation among a great many possible implementations. To give another example implementation, the fact tables that may be provided in the staging database OF FIG. 1 may include the following, each having some or all of the indicated fields, inter alia:

Publications
id
url
created_at
updated_at
catalog_id
upload_date
crawl_time e.g. the time the URL containing the metadata for this publication was downloaded, as reported to the staging system.
catalog_record_id
title
description
keywords
category
language
temporal_bounds
spatial_bounds
contact_name
contact_email
contact_phone
publisher
access_level
access_level_comment
license
issue_date
release_date
last_update_date
update_frequency
bureau_code
program_code
data_quality bool
english_title
english_keywords
english_category
english_description
translated_title
translated_description
translated_category
translated_keywords

catalogs
id
created_at
updated_at
catalog_type
base_url
suspected_url
assignee
official_publication count
name
publication_count
credentials

components
id
created_at
updated_at
size
file_type
digest

downloads
id
component_id
filename
crawl_time
status_code
content_type

links
id
created_at
updated_at
publication_id
label
url_id

Similarly, the DIMENSION tables and fields thereof need not be as per the above example implementation. The dimension tables in FIG. 1's staging database may for example include, inter alia, one or both of the following, each including some or all of the following fields:

dim_catalog
id
catalog_id
level
country
language
location
first date

dim_country
id
iso
name
dim_catalog_id

More generally, the staging system database may include any suitable ER (entity relationship) database, and may also include aspects of an enterprise data warehouse or EDW including dimension tables and conversion of suitable existing tables into fact tables.

It is appreciated that additional tables may be added as appropriate such as some or all of the following:
According to some embodiments, when end-users ask questions against the search engine, data is trapped to populate a Session table e.g.
Session (holds information end-users' web sessions during which they launch questions against search engine and may capture FACT type information about the interaction among end-users and the ‘component’ and/or ‘publication’ fact table/s. Fields may include all or any suitable subset of:
   id (unique session_id)
   party_id (unique id of person or organization that did the session)
   session_start_timestamp (date and time when session started)
   session_end_timesstamp (date and time when session ended)
   session_start_url (where did the end-user landed first at the beginning of the session?)
   session_exit_url (what was the last url that the end-user used before departing the session and moving elsewhere on the web?)
session_x_query and query tables may also be defined to hold data on specific search strings that the end-user used as queries to a given session.
A suitable summary table of session may be provided, e.g. as follows:

Session_Summary
session_id (one id here for every id in session table)
number_of_queries_launched
total_session_time (amount of time (say, 20 minutes) session lasted
total_recommendations (number of reccommendations our system showed the user during the session)
and all other information we will find useful to summarize and analyze.
   Typically the system harvests information about ‘publication’.‘component’ and other similar tables like ‘url’. The system may take unique IDs from dimension tables (e.g. unique id of (say) Israeli Ministry of Finance or the unique id of a timestamp or the unique id of a language) and add these as keys to suitable rows in the publication and component tables. The system may consult summarized information in analytical tables e.g. session table above, in order to build better heuristics and generate better ‘guesses’ on how to cleanse or complete uncleansed or incomplete information.

It is appreciated that the tables above are in no way intended to be limiting. Yet another possible alternative staging schema is now described by way of example: “Catalog” contains zero or more “Publication(s).” “Publication” contains zero or more “Link(s).” For example, a Publication that is closed will have zero links. A “URL” is referenced by zero or more “Link(s).” For example a Link to a data dictionary by NOAA could be referenced by thousands of URLs. A “URL” has zero or more “Downloads.” A “Component” is downloaded zero or more times. A “Component” is decorated with various extracted data. For example, a sub-component is for files that contain other files such as zip file with a parent for the zip and children for the files contained in the zip file.

Entities for this staging schema inter alia may include some or all of:

ComponentURL—The action of clicking on URL (man or software) produces a Component per a given date and time and per the properties of the requesting IP address (ex: we may deny a request from Israel for a component. Another example: an organization can restrict a ComponentURL to deliver the component only to authenticated computers within the organization). If we click on the same URL several minutes later, we may receive a different ComponentURL.
Component—The contents of a file. The contents may conform to a certain type such as html, zip, csv, pdf, json, geo-jason, xml.
Publication—A segment of a Server that has a unique identifier and associated (optional metadata). Ex: a “Publication” in HHS' CKAN Server calls “Publications” by the name “Packages.” In USDA's data.jston Server a “Publication” is called “Entry” or “Dataset.”
Server—Physical server which provides multiple publications through an API type. For example: usda.gov/data.json.
Link—The inclusion of a URL in a publication with Metadata. A Publication may have zero or more Links. A Link has a publication_id and a url_id. A link contains metadata that describes the URL.
URL—A web address that you can type in the address bar of a browser. We retrieve the URLs from Links. We save URLS because two different links can point to the same URL.
Subcomponent—Represents the inclusion of one component inside another component. Ex: Zip files. Ex: a license-type component could be included inside the components of many different publications.

Suitable Relationships, Cardinality, Referential Integrity (RI) and/or operations may be defined.

DDL may for example include some or any subset of:

CREATE TABLE

“catalogs”

(“id” INTEGER PRIMARY KEY AUTOINCREMENT NOT NULL

, “created_at” datetime
, “updated_at” datetime
, “catalog_type” text
, “base_url” text
, “organization_id” integer);

CREATE INDEX “index_catalogs_on_organization_id” ON “catalogs”

(“organization_id”);

CREATE TABLE

“organizations”

(“id” INTEGER PRIMARY KEY AUTOINCREMENT NOT NULL

, “created_at” datetime
, “updated_at” datetime
, “name” text
, “parent_id” integer);

CREATE INDEX “index_organizations_on_parent_id” ON “organizations”

(“parent_id”);

CREATE TABLE

“publications”

(“id” INTEGER PRIMARY KEY AUTOINCREMENT NOT NULL

, “url” varchar(255)
, “created_at” datetime
, “updated_at” datetime
, “catalog_id” integer
, “publication_time” datetime);

CREATE INDEX “index_publications_on_catalog_id” ON “publications”

(“catalog_id”);

CREATE TABLE

“roles”

(“id” INTEGER PRIMARY KEY AUTOINCREMENT NOT NULL

, “name” varchar(255)
, “resource_id” integer
, “resource_type” varchar(255)
, “created_at” datetime
, “updated_at” datetime);

CREATE INDEX “index_roles_on_name_and_resource_type_and_resource_id” ON “roles”

(“name”

, “resource_type”
, “resource_id”);

CREATE INDEX “index_roles_on_name” ON “roles”

(“name”);

CREATE TABLE

“users”

(“id” INTEGER PRIMARY KEY AUTOINCREMENT NOT NULL

, “email” varchar(255) DEFAULT “ NOT NULL
, “encrypted_password” varchar(255) DEFAULT ” NOT NULL
, “reset_password_token” varchar(255)
, “reset_password_sent_at” datetime
, “remember_created_at” datetime
, “sign_in_count” integer DEFAULT 0 NOT NULL
, “current_sign_in_at” datetime
, “last_sign_in_at” datetime
, “current_sign_in_ip” varchar(255)
, “last_sign_in_ip” varchar(255)
, “created_at” datetime
, “updated_at” datetime
, “name” varchar(255));

CREATE UNIQUE INDEX “index_users_on_email” ON “users”

(“email”);

CREATE UNIQUE INDEX “index_users_on_reset_password_token” ON “users”

(“reset_password_token”);

CREATE TABLE

“users_roles”

(“user_id” integer

, “role_id” integer);

CREATE INDEX “index_users_roles_on_user_id_and_role_id” ON “users_roles”

(“user_id”

, “role_id”);

CREATE TABLE

“schema_migrations”

(“version” varchar(255) NOT NULL);

CREATE UNIQUE INDEX “unique_schema_migrations” ON “schema_migrations”

(“version”);

CREATE TABLE

“subcomponents”

(“parent_id” integer NOT NULL

, “child_id” integer NOT NULL
, “filename” text);

CREATE TABLE

“urls”

(“id” INTEGER PRIMARY KEY AUTOINCREMENT NOT NULL

, “url” text);

CREATE TABLE

“links”

(“id” INTEGER PRIMARY KEY AUTOINCREMENT NOT NULL

, “created_at” datetime
, “updated_at” datetime
, “publication_id” integer
, “label” text
, “url_id” integer);

CREATE INDEX “index_links_on_publication_id” ON “links”

(“publication_id”);

CREATE INDEX “index_links_on_url_id” ON “links”

(“url_id”);

CREATE TABLE

“component_urls”

(“id” INTEGER PRIMARY KEY AUTOINCREMENT NOT NULL

, “url_id” integer
, “component_id” integer
, “filename” text
, “time_crawled” datetime);

CREATE INDEX “index_component_urls_on_url_id” ON “component_urls”

(“url_id”);

CREATE INDEX “index_component_urls_on_component_id” ON “component_urls”

(“component_id”);

CREATE TABLE

“components”

(“id” INTEGER PRIMARY KEY AUTOINCREMENT NOT NULL

, “created_at” datetime
, “updated_at” datetime
, “size” integer
, “file_type” varchar(255)
, “digest” varchar(255));

CREATE INDEX “index_subcomponents_on_child_id” ON “subcomponents”

(“child_id”);

CREATE INDEX “index_subcomponents_on_parent_id” ON “subcomponents”

(“parent_id”);

FIG. 4 aka TABLE 1 is an example which illustrates relationships with a publication including a report on cotton production in the US state of Alabama in 2007, the report containing files for each county in Alabama. Relationships may be discovered using conventional natural language processing techniques based on any suitable operational definition of each relationship. For example, relationships, which are discovered, may include any or all of
temporal—a suitable rule for identifying this relationship may for example be: tabular data with similar columns/fields as well as, say, same publishing entity, same geospatial region, different publication dates, different effective dates (which is an EDW term indicating the period of time data applies to, e.g. the earliest timestamp we find in the data itself, or an extracted timestamp (for example 2008) from the publication metadata. Typically, publications having a temporal relationship differ in data content and dates, but the affected areas aka geospatial bounds/description field as stored in the table/data dictionary may be the same. The Data dictionary typically includes a document that describes the data types and how to understand a data set. Any suitable similarity metric may be employed to determine similar columns/fields e.g. same field names/types typically within some predefined tolerance e.g. any one field, but not two, may be different in name and/or type; two specific fields, but none other, may be different, and so forth.
geographical—tabular data has similar columns, differing geospatial regions (e.g. metadata known to describe region, differs)
categorical publication metadata (e.g. category field in publications table described herein) describing the “category” that the publication pertains to, differs but many or most other metadata are the same. (e.g. corn production vs. potato production)
   duplicate—identical data files, similar metadata (various similarity functions defined for different data types. For example, one site might include month and day, whereas another site will truncate dates to include only the year. So dates may be compared via range inclusion.
   subset—one publication contains another e.g. one publication's data file is entirely included in another publication's data file and/or one publication includes a set of data files which is a subset of the set of data files included in another publication.
Collation (similar to aggregation, except that rather than actually combining the data, data was simply gathered into one place such that all data files from the smaller publication are in the larger one, without change.
   aggregation—geospatial or temporal are subsets of the other, but data is different. For example, one publication pertains to “Alabama”, the other to “Southern USA” and a predefined ontology used by the system has “Alabama” defined as a subset of “Southern USA”. Or, similarly, one publication's metadata indicates it pertains to “August 2017” whereas the other's metadata indicates it pertains to “2017-2018”.
   translation—two publications whose metadata is in different languages however metadata is similar or identical (as defined e.g. by suitable open source libraries for the NLP similarity task) once translated (e.g. by using a translating functionality to machine-translate all non-English metadata to English)
mirroring—identical publications hosted on different servers.
   Duplicate: identical publications contained in catalogs which are different, and/or controlled by different entities Typically relationships aka relations between publications, may be pre-determined as logical conditions imposed on suitable fields of the publications fact table described herein. For example, if a particular field compared between the two publications is identical or included one in the other, and various other fields are non-identical, relation x exists between those publications. It is appreciated that the specific relations defined herein by way of example may have different operational definitions or may not be provided at all. Also relations not defined herein may be provided as appropriate.

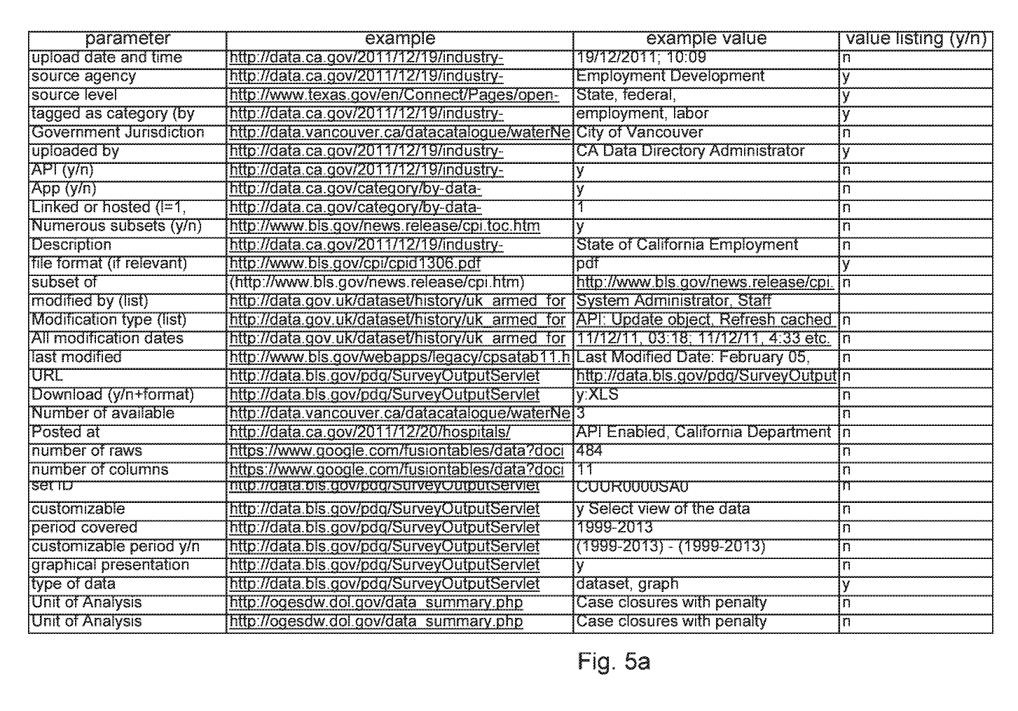

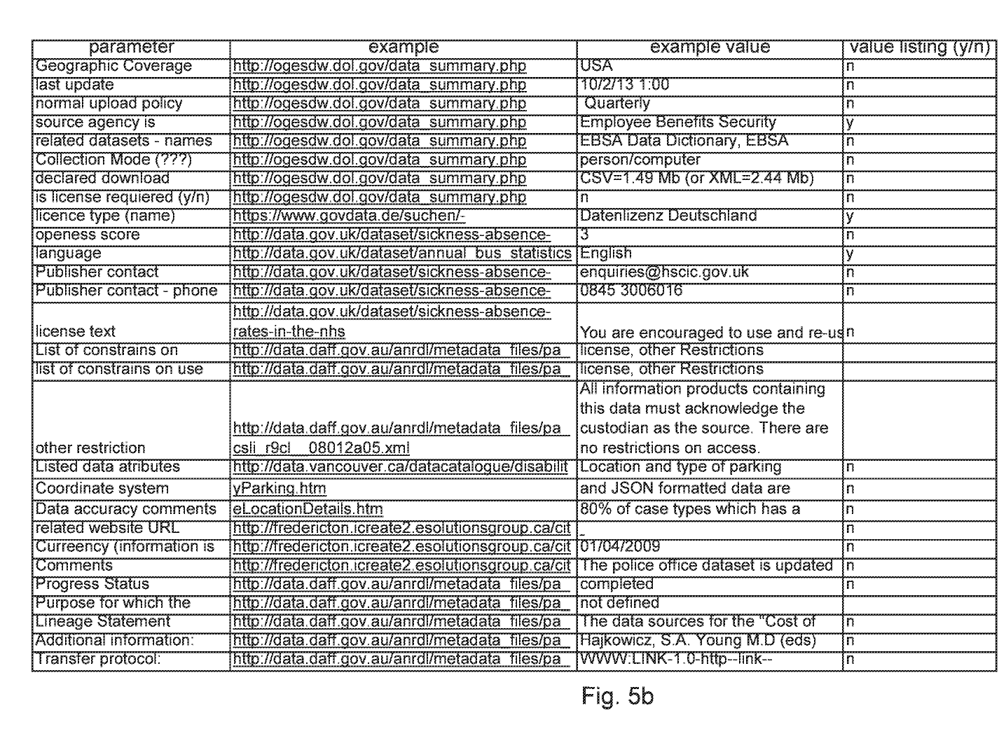

FIGS. 5a-5b, taken together, illustrate an example of a table whose first column stores attributes/properties/fields/characteristics of metadata collected and store in the staging area. Some properties may have been collect from the web and others generated by the system shown and described herein. These may all be staged as described herein and prepared for delivery and presentation per end-user requests. Any or all of the properties in the table of FIG. 5 may be collected/generated as part of the crawling/relationship discovery flows described herein below. The values stored under these properties/fields may be used by the system in order to track, monitor, debug, and address end-user queries regarding, say, accuracy, timeliness, quality, and ‘genealogy’ of values of various publications.

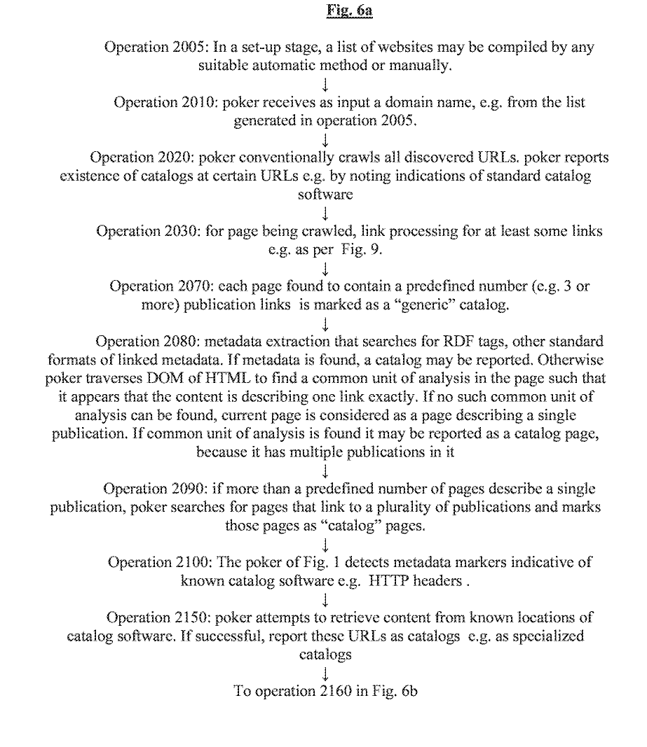

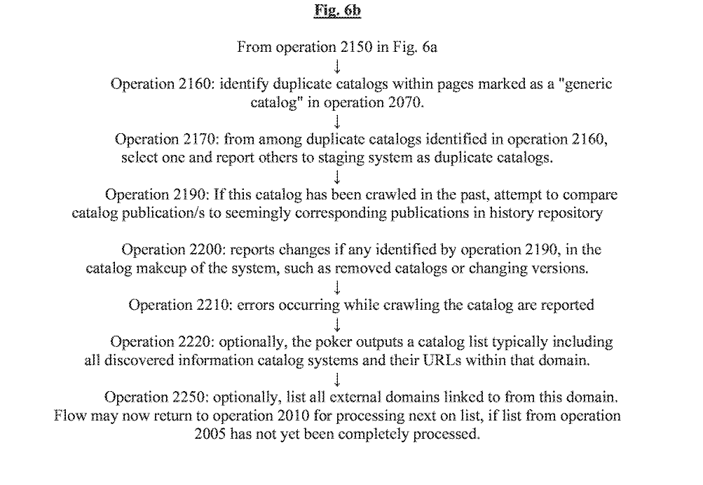

FIGS. 6a-6b, taken together, illustrate a method by which the crawler aka poker software system of FIG. 1 identifies catalogs running on a host in a network environment by crawling websites. This method may be termed a “crawling method” or a “catalog identification method” and typically includes downloading pages, and adding discovered links back to the queue and reporting publications to the staging system and optionally adding to the number of publications/metadata/catalogs.

The input of the crawling typically includes a domain name. The output typically includes catalogs that are reported to the staging system and/or (e.g. for certain specialized crawlers such as CKAN, data.json) publications reported to the staging system of FIG. 1.

Some or all of the following operations may be performed, suitably ordered e.g. as follows:

Operation 2005: In a set-up stage, a list of websites may be compiled by any suitable automatic method or manually. For example, human experts can review suitable information (say, the US Federal manual of government) and generate a list of all US Government agency websites. Optionally, some or all of the following may be performed: set up database schema, run/configure redis or any other key-value store, rabbitmq or any other task queue, providing a lock manager.

Operation 2010: poker receives as input (e.g. manually entered, being scheduled in a queue, running as part of a periodic job, being staged in a distributed queue during the lifetime of a project requiring search of categorized data).

a domain name, such as, for example, “nasa.gov”.

Operation 2020: poker conventionally crawls all the URLs discovered as part of the crawling process, typically, crawl all the URLs found in the process of crawling, stopping when the list of all URLs discovered as part of the same process is exhausted.

All the URLs discovered as part of the crawling process are typically limited to URLs that refer to locations with the same domain name. As per RFC 3986, URLs may be either Relative URLs, which may always refer to a location with the same domain name, or Absolute URLs, which may have a domain portion which must be the same as the site currently being crawled.

Based on HTML tags such as <meta> and <link rel=alternate> in the <head> section that are indicative of or declare the presence of standard catalog software, the poker reports the existence of catalogs at these URLs.

Operation 2030: for the current page being crawled, for at least some links (e.g. <a> tags with valid URLs in the href attribute) on the current page being crawled perform link processing e.g. some or all of the operations 2340, 2350, and 2360 in flow 1a illustrated below in FIG. 9.

Operation 2070: each page found to contain a predefined number (e.g. 3 or more) publication links may be marked as a “generic” catalog. Typically, the staging system exposes an API that allows the poker/crawler to query if a URL is a publication's primary page. If it is, then the URL is considered a publication link and may be marked as a “generic” catalog. Typically, the system includes a table storing urls of all catalogs e.g. the catalog table and catalogs table both described herein. The term “publication links” is intended to include any link that points to a page describing a single publication.

Operation 2080: poker then applies metadata extraction that searches for several sources of metadata: for example, RDF tags, other standard formats of linked metadata, etc. If metadata is found, a catalog may be reported. If no metadata is found, the poker aka crawler traverses the DOM of the HTML to find a common unit of analysis in the page such that it appears that the content is describing one link exactly. This may be done e.g. by a tree traversal to find the nearest common ancestor tag in the DOM from the publication links themselves. If no such common unit of analysis can be found, then the current page is considered as a page describing a single publication. If common unit of analysis is found it may be reported as a catalog page, because it has multiple publications in it

Operation 2090: In the case that there are more than a predefined number of pages (e.g. 3 pages) describing a single publication, then the poker searches for pages that link to a plurality of publications and mark those pages as “catalog” pages.

Optionally the poker can search the site (e.g. set of pages under the domain discovered in this process, colloquially referred to as a “website”, or “site”) using a model (e.g. NLP and/or RNN model) that is trained against the site as a whole to find the relevant metadata fields. The heuristic models used here may be “trained” by a human operator to better recognize catalog systems. This may for example be done using RDF tags. RDF is a well-established standard with standard tools to assist with its discovery. Nokogiri is a Ruby library, which may be used for parsing HTML/XML, and to pull out all elements that list Dublin core metadata attributes, and other, related RDF attributes.

Operation 2100: The poker of FIG. 1 detects metadata markers, to assist in determining if a server is running well known catalog software—such as, for example, HTTP headers. E.g., CKAN, which is an example of a catalog that uses HTTP Headers, sets the “X-CKAN-API-KEY” header by default.

Operation 2150: poker attempts to retrieve content from well-known locations of catalog software within a system, such as “/data.json”, “/sitemap.xml”, etc. If these attempts are successful, these URLs are reported as catalogs to the staging system as well. It is appreciated that these are typically not generic catalogs, but rather specialized catalogs with specialized code that is capable of reporting the publications contained therein to the staging system

Operation 2160: check for duplicate catalogs e.g. identify duplicate catalogs within pages marked as a “generic catalog” in operation 2070. Typically, If the catalogs discovered as part of the crawling process have the exact same publications, all but one are discarded, functionally or physically.

Operation 2170: from among duplicate catalogs identified in operation 2160, select one e.g. the “generic catalog” with the shortest URL, and report all the others to the staging system as duplicate catalogs. Operations 2160, 2170 in combination typically at least remove multiple generic HTML catalogs (or may remove all catalogs not just those which are generic) that contain the exact same publications, with the same metadata.

Operation 2190: If this catalog has been crawled in the past, the poker may attempt to compare at least some of the catalog's publications to seemingly corresponding publications found in the past and stored in a suitable history repository (e.g. including the catalogtype specific catalog/publication tables described herein) storing the history of the same catalog. Only some publications (e.g. randomly sampled publications from the catalog), rather than all, may undergo this operation

Operation 2200: the poker reports changes if any identified by operation 2190, in the catalog makeup of the system, such as removed catalogs or changing versions. For example, Removal may be reported if a CKAN system was used, and discovered in the poking process, but in the last month it is not found. Therefore, the CKAN system is deemed to have been removed. Conversely, if a CKAN (say) catalog was not there before, and is there now, that catalog was added. A Version change may be reported if a data.json 1.0 catalog was found, and this catalog since changed to data.json 1.1. Typically, separate non-compatible crawlers may be provided for each of these.

Operation 2210: In the case of an error (e.g. HTTP 400-599 error, syntax error in data returned such as malformed JSON or XML, etc.) while crawling the catalog, the poker reports which error occurred to the staging system of FIG. 1, and stops crawling the catalog. For example, to detect errors in JSON, the system may try to parse the JSON. In the event of failure, the system may check for recoverable errors, such as the presence of a UTF BOM mark, or converting TRUE and FALSE to true and false. To detect errors in other catalog systems the system may find, say, an HTTP 5xx status code as defined in Section 10 of RFC 2616 (say). And/or the system may find syntax errors in the JSON/XML, responses.

Operation 2220: optionally, the poker outputs a catalog list typically including all discovered information catalog systems and their URLs within that domain. For example, the list may include all “generic catalogs” found in operation 70 above, minus those found, in operation 160, to be mere duplicates, and any specialized catalogs such as data.json, CKAN, etc. discovered in operation 200/250.

It is appreciated that the poker/crawler may operate in batch mode, e.g. may be manually run separately for each domain. Alternatively, the crawler may automatically report catalogs to the staging system as part of its normal operation and without manual intervention in which case operation 1000 may be omitted.

Operation 2250: optionally, list all external domains linked to from this domain. This list may be separated into two groups: a list of all subdomains, and the rest. (Subdomain: a domain name of which the current domain is a suffix. E.g. jpl.nasa.gov is a subdomain of nasa.gov.)

The method of FIG. 9 aka Flow 1a typically includes some or all of the following operations, suitably ordered e.g. as follows:

Operation 2340: poker determines if the URL of the link is internal (refers to a location with the same domain name) or external (e.g. an absolute URL with a different domain portion).

Operation 2350: For an external link, the poker reports the domain currently undergoing crawling e.g. as per operation 2020, to the staging system of FIG. 1 for future investigation (e.g. the staging system may remove any duplicate reports, (not to be confused to de-duping publications based on relationship discovery there between e.g. by fllow2 described herein). Typically, the staging system keeps a list of domains that have been reported. The flow may run this query: SELECT*FROM domains_for_inspection WHERE domain=‘xxx’; and insert the record if the record isn't there yet. This table may have the standard set of three columns/fields described herein for other tables, plus a “domain” column of type text. The crawler may or may not deal with subdomains automatically.

Operation 2360: poker schedules for crawling all internal links that have not yet been crawled. crawling may be restricted e.g. only to URLs that match a specific path, an/or only to only follow up to 50 (say) links, and/or only to follow certain links e g links that are not marked as “rel=nofollow” (e.g. as an attribute on the <a> tag).

FIG. 7 illustrates a simplified flow, aka FLOW2, for Detecting Relationships Between publications (aka Web Content Items aka WCI's), included in at least one catalog. FIG. 7 may for example be implemented using the embodiment of FIG. 3a or that of FIG. 3b. If desired, duplication is one of the detected relationships and de-duping may be performed accordingly Typically the system does not delete duplicate publications, and instead marks aka records in memory, the existence of a “duplicate” type relationship between them. The input of de-duping typically includes a set of publications some of which are duplicates, the output typically includes a set of non-duplicate publications. The scheduling in flow2 may be facilitated by the distributed queue component of FIG. 1.

Flow 2 is typically performed each time a publication is reported to the staging system. For example, the staging system of FIG. 1 may expose an API endpoint to allow the crawler system to report publications. When such a report comes in, the system may look up that report in the staging database e.g. by catalog and “publication id” (publication's unique identifier within the external catalog to allow publication to be reported to system and be processed by crawler/poker and staging as described herein. If the metadata is either for a new publication, or is different from the metadata previously crawled, flow2 is run on that metadata. Reporting in this case may include running a POST HTTP request against the aforementioned API endpoint with a JSON body describing the publication metadata.

The crawlers may be run once a week or at any other suitable interval. Typically, the crawling system reports publications to the staging system as part of that crawling process, to enable tracking of when a publication has ostensibly been removed from a catalog. Flow2 typically includes some or all of the following operations, suitably ordered e.g. as shown:

Operation 2510: For each new or updated publication reported to the staging system, schedule the publication's links for component crawling, and for relationship discovery. It is appreciated that a publication may be reported again despite nothing having changed e.g. if the crawler state is wiped between runs. Wiping of the crawler state cannot be assumed to be a zero-probability occurrence since crawler state may be wiped, even multiple times in the course of a single project, inter alia due to power loss, human error or sabotage, bad memory, under voltaged CPU that destroys data.

Operation 2520: The crawling system attempts to download the links from the publication

Operation 2525: for each downloadable component, the system extracts from that component, metadata (aka component-level metadata) over and above the metadata already reported to the staging system. In the case of tabular data, the crawler can extract at least any or all of: the number of rows, names and types of columns, and statistical markers of the data (e.g. mean, median, variance, minimum, and maximum for numerical data, mode for categorical data), and store this as metadata of the tabular data. For document data, the crawler can extract at least any or all of: authorship information, any tables embedded within the document, document length (pages, lines, words), reading level, estimated reading times. The component crawler aka poker of FIG. 1 which may perform flow1 is typically capable of understanding a few other file types, of which geospatial information is relevant for, and often extremely useful to, GIS maps, GeoTIFFs, GeoJSON, and other similarly specialized file types. The poker system of FIG. 1/flow 1 may share the same code, task queue, and may have a similar API for reporting components to the staging system.

Operation 2530: typically in parallel to operation 2520, each publication is scheduled for advanced metadata extraction. This is typically performed in parallel to the component downloading operation 2520 (and downloaded content processing operation 2525) by the staging system. Operation 2530 may include:

Operation 2530a: publication metadata is machine-translated into a common language e.g English or another common natural language, by an external service. And/or

Operation 2530b: the staging system extracts additional metadata fields, such as, for example, applicable time periods and geographical regions from the textual fields of the publication metadata e.g. in the publications table, described herein, the textual fields may include only title, description, category, and keywords; other fields may not be machine-translated. An example would be if the title includes 2008 Agricultural Production Report for Fulton County, Ga.; the system may extract 2008 as the time period, Fulton County, and Georgia as named entities, and agricultural as a keyword. Resulting descriptions may be much longer, hence far more detailed and useful, than when the title is simply “Agricultural production report”. This can be done e.g. by using named entity extraction as part of commonly available NLP (natural language processing) libraries. For example, IBM Alchemy, Google Natural Language API, NLTK, and Stanford NER are all open source libraries that perform named entity extraction.

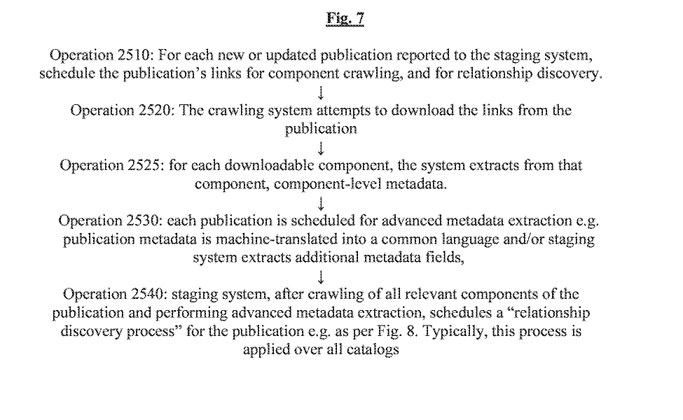

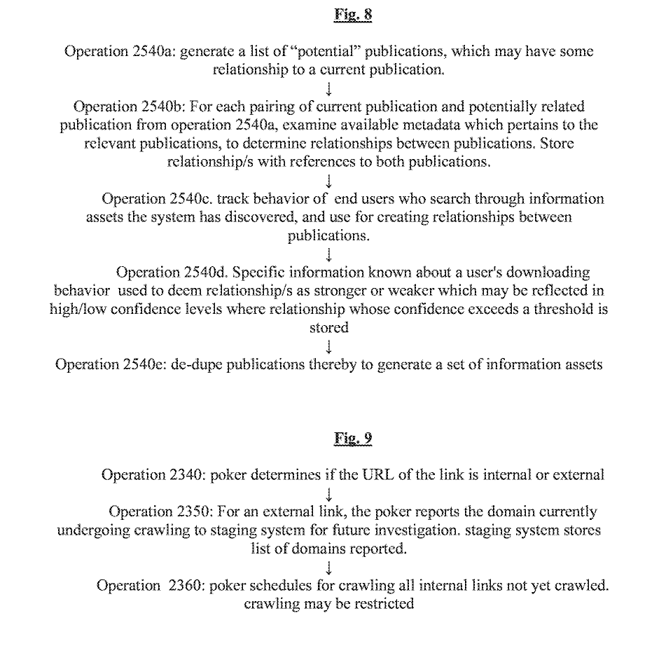

Operation 2540: staging system, after crawling of all relevant components of the publication and performing advanced metadata extraction, schedules a “relationship discovery process” for the publication. The output of this relationship discovery process” may be used in deciding if two publications are related or not. Typically, this process is applied over all catalogs since, for example, a seemingly unrelated Australian government catalog might republish NASA data. The relationship discovery process” typically includes some or all of operations 2540a-2540e in Flow 2-1 as shown e.g. in FIG. 8. Scheduling here and/or in operation 2530 above, may include adding a particular process or task to a distributed queue of tasks. That queue then uses suitable e.g. conventional distributed queue technology to manage the system workload by distributing tasks across a cluster of servers included in the “staging server” (server cluster e.g.) of FIG. 1.

Typically, relationship discovery (e.g. As per operation 2540 in flow2) includes relationship categorization (e.g. as shown in FIG. 3a or 3b or as described below). According to some embodiments, for pair of publications found to be related in relationship discovery operation 2540—the relationship/s between that pair of publications is categorized e.g. the relation between them is typified. If the relation is “duplicate”, then typically, the system does not delete duplicate publications, and instead marks aka records in memory, the existence of a “duplicate” type relationship between them. If the relation between that pair of publications is any type (e.g. Temporal, geographic etc.) other than “duplicate” then typically, the system marks aka records in memory, the existence of that type of relationship between them; these relationships may be used to determine what search results are shown by a search engine. For example, rather than simply showing a particular publication as a search result, the search engine may also show other publications which have certain pre-stipulated relationships with the publication which comes up as a search result. For example, a search query might result in a search result (a publication) plus a list of “related publications” which may include sublists for publications, which are temporally related, geographically related, etc.

FIG. 8 illustrates a simplified “FLOW 2-1” aka—“relationship discovery process” operative for discovering relationships between publications. Any or all of operations 2540A-2540e may be provided, suitably ordered e.g. as shown. Typically this process is run to discover not only relationships between publications within a single catalog, but also relationships between publications in completely different catalogs. According to some embodiments, the relationship discovery process is run each time a publication is reported which is not entirely identical including metadata, to an existing publication. The relationship discovery process may be performed pairwise e.g. each just-reported publications vis a vis all other known publications, or many e.g. 99% of possible pairings can be discarded in advance as pairings which clearly would have no relationship, thereby becoming far more efficient. “Discarding” typically does not involve any physical discarding. Instead, a list of candidates is generated e.g. based on basic conditions or criteria e.g. those listed below. As such, the set of candidates may then include the union of (at least) all the following sets:
publications that share a primary keyword. Keywords listed in the original metadata are “primary”, as are keywords with a weight over a predetermined threshold e.g. 0.5.
publications that share a single URL
publications that share geospatial or temporal bounds
publications that share components
publications whose tabular components share a common/similar schema (similar in this case means all but one field, this is configurable and may be changed)
   It is appreciated that other criteria may be used in addition to or instead of the above. For example, if in a particular application it is required that a publication must have the same title for a specific type of relationship, the list of basic criteria may include publications with the same title. Each type of relationship may have its own list of basic conditions/criteria to be used to efficiently generate a list of candidates.
   The operations, which may be included in FIG. 8, are now described in detail:

Operation 2540a: generate a list of “potential” publications, which may have some relationship to a current publication. Relationship discovery may be performed for each entry in a publications table stored in the staging server database; as each entry undergoes relationship discovery it is termed “current publication” until relationship discovery is completed for that current publication and the next entry is taken up and becomes the current publication. It is appreciated that operation 2540a is typically (or not necessarily) a batch process, and instead may under normal operation be triggered by even a single publication being reported to the staging system.

Operation 2540a typically compiles a list of potentially related publications based on one, all or any other suitable subset of shared links as part of the publication, similarity in title and other textual fields (after translation), and comparison of digests and schemas of the actual data. Plural publications e.g. a potential publication and a current publication may be evaluated for potential relationships there between by comparing the publications e.g. based on textual similarity (using the vowpal wabbit library, for example, or by searching for subsets of keywords in a full text search index). Operation 540a also adds publications with shared links or components (meaning that both publications list the same urls, or that the same file content was downloaded from different urls). Typically the actual component content is analyzed to extract column names/types from tabular data (such as csv files). Tabular components with identical schemas (column names/types) may be identified, and any publications, which contain such, are marked as potentially related (aka potentially linked).

Operation 2540b: For each pairing of current publication and potentially related publication from operation 2540a, the relationship discovery engine of FIG. 3 typically examines available metadata e.g. all metadata stored in the system's fact and dim tables and/or all relevant metadata in the staging system database, which pertains to the relevant publications, to determine whether one (or more) of several predefined relationships between the publications, exist/s. Example relationships are described herein with reference to the table below. The primary aka current publication typically includes that scheduled in operation 2540.

The relationship itself is stored in a “publication relationships” table, typically a fact table with references to both publications. This table's fields may include some or all of the following:
publication_relationships
id, created_at, and updated_at—These fields may be provided in substantially any of the tables described herein, such as but not limited to publication_relationships. id typically includes a surrogate key (term of art, defined e.g. in published data modeling works by Edgar Codd and Ralph Kimball. created_at, updated_at typically include physical timestamps representing when an individual row in the table in question was first inserted into the database, and when it was last updated by the application or any of the functionalities described herein.
from_publication_id
to_publication_id
relationship_type
confidence
additional_metadata—e.g. stored as JSON
   The “publication relationships” table may also store some or all of: when each relationship was discovered, what type of relationship it is, and/or the system's level of confidence in the existence of that relationship between the 2 publications.
   Such relationships are tagged with additional metadata, which may for example be Stored as JSON in the additional metadata field of the publication relationships table. The additional metadata may for example include:
(a) the proportion of duplication e.g. % of identical metadata fields, since duplicate publications tend to have mostly identical metadata (for example, metadata may be identical except that 1 of the 2 publications is missing a publication date, or has a different point of contact relative to the other), and/or or % of identical links in the 2 publications since duplicate publications tend to have mostly identical links (for example, 2 duplicate publications may have identical links except that 1 of the 2 publications has an extra link e.g. to a data dictionary or license)
(b) which revision of the metadata a specific relationship applies to. Typically, catalogs are crawled over time e.g. periodically, hence the system is able to track the history of a given publication (catalogs assign unique identifiers to each publication). A revision table or revision field in a suitable one of the fact/dimension tables may be provided, or the revision data may be stored as part of EDW functionality.

Operation 2540c. If the system is exposed to end users who search through the information assets aka data assets the system has discovered, User behavior can be tracked and used for creating relationships between publications. For example, temporally adjacent (e.g. in a single session) searches 1, 2 yielding publications 1, 2 as respective search results may be regarded as evidence of a relationship between publications 1, 2. viewing publications 1, 2 in a single session for download and a fortiori for purchase may be regarded as evidence of a relationship between publications 1, 2 since a temporally adjacent purchase is, in many cases, a much stronger indication that two publications are related than merely viewing them at a temporally adjacent points in time.

Operation 2540d. Specific information that is known about a user may be used to consider that relationship as being stronger or weaker (for example, if someone downloads every publication they come across, then the links they create would be weaker as compared to a user who works in the sewage department and downloads a small number of publications). This strong/weak characterization may be computed on the fly e.g. By the relationship discovery table, e.g. As a function of the number of downloads per day, and stronger signals may be assigned for users with older accounts. Strength/weakness may be reflected in high/low confidence levels (e.g. On a scale of 0 to 1), respectively, characterizing the relationship. A suitable table may have a “confidence level” field and/or the staging system may add a row for every relationship whose confidence is over 0.5 (or whatever the predetermined threshold has been set to be)

Operation 2540e: Once a set of publications is de-duped, the result is a set of unique publications (i.e. with no duplicates); each of those unique publications is considered an “information asset”. Each information asset may be associated with a single unique publication or with plural duplicate publications.

It is appreciated that operations 2540A-2540E may be provided standalone or in any suitable sub combination or order. Also, these operations if combined with others, need not be combined with any specific operation from among operations 2510-2540 described herein and certainly need not be combined with all of operations 2510-2540. Any other method for eliciting additional characterizing information e.g. metadata may be employed, as suitable for application-specific analysis rules to discover whichever relationships are deemed suitable for a particular application. Specific operations 2510-2540 may be omitted e.g. if the specific type of relationship they target is not deemed useful for a particular application.

It is appreciated that flow2 is applicable for discovering a wide variety of relationships between publications, e.g. the example relations of FIG. 4, which may be deemed useful for particular applications; duplicates are just one type of relationship that may be useful for applications which demand deducing. Deduping may for example include removing all discovered duplicates from an initial set of publications, and for each one, remove all its duplicates from the set.

It is appreciated that flow1 herein need not include only the generic HTML crawler herein and need not report only “generic” catalogs. Instead, flow 1 may if desired for certain applications also include specialized crawlers. Generally, catalogs may be discovered e.g. using Howl herein or any other conventional discovery method. Publications from catalogs may be crawled and reported to the staging system herein. As publications are reported to the staging system, flow 2 may be employed to discover relationships between publications reported to date. According to some embodiments, metadata from all instances of each identified information asset is united. According to some embodiments, a single instance of each identified information asset is selected to be served to end-user responsive to search request targeting that information asset. That instance may be linked in memory, by the system, to all other instances of the same information asset.

Generally, Component crawling (aka flow1) may be performed by the crawling system of FIG. 1 whereas Relationship discovery (aka flow2) may be performed by the staging system of FIG. 1 except for Operations 2520-2525 which are performed by the crawling system.

Regarding FIG. 2a, Content type is an example of an http header that yields an indication of content. Typical values include text/html, application/json however many more such are possible, e.g. as defined by RFC.

It is appreciated that FIG. 2a's block 150—“check for known catalog signatures” and its counterpart in FIG. 2b, may be implemented by operations 2100, 2150 in flow1.

It is appreciated that the embodiment of FIG. 2b may be provided with suitable variations. For example, regardless of cached status, crawling may continue. There is the chance that the homepage of the domain currently being crawled hasn't changed, but one of the pages that the homepage links to has changed or been updated. Optionally, a software functionality is operative to store in memory, which “crawl job” the page was last crawled for (e.g. the timestamp of when the system started crawling that domain. Regarding the term “crawl job”, typically, each time the crawler begins crawling a domain, all the URLs crawled as a result are deemed part of a single “crawl job”. Any suitable unique identifier may be employed for the crawl job such as the timestamp at which the crawler began crawling that domain e.g. the domain as in flow2 herein. If the URL has already been crawled in the current job, the poker or crawler typically stops processing the URL currently being processed and moves on to the next URL. If the URL has not yet been crawled in the current job, then the poker or crawler may for example send a get request with etag/timestamp and use the cached version of the content downloaded for the URL for processing as per this flow, if the server that responds to requests for the domain being crawled/the requested URL gets a 304 not modified. More generally, the flow is that if the URL is cached, the system uses the cached content whereas if the URL is not cached the system is operative to download the content when the URL location is requested from the server looking HTTP, and store that content electronically e.g. in a cache (redis e.g.) e.g. provided in operative association with the system of FIG. 1 either as separate hardware or in a database in FIG. 1 or in server memory. Once the content has been downloaded, the poker may mark the URL as having been crawled for the current job and may update the etag sent back from the server and/or timestamp indicating when URL downloading was completed. It is appreciated that the above is but one possible process for downloading and storing the downloading result in a cache; other processes are possible.

Queues 630, 645 in FIG. 3b and their counterparts in FIG. 3a, typically include separate queues managed by the same system. typically, the staging system of FIG. 1 pulls tasks off the queue to work on. These and the queue used by the crawler may or may not use the same distributed queue management scheme e.g. the same rabbitmq.

Some embodiments herein make use of a discovered publication even if its associated data files are lacking. for example, the system may use this information to alert for lack of open data requirement compliance because while a particular entity's catalog lists metadata about hundreds of publications, no data is not found for these publications. Also, a publication's metadata does often actually describe data files that an end-user can download and use.
A suitable technical profile for open data is, for example, the US governmental memorandum M-13-13 that defines open data. The memorandum states however that open data components must be published in machine-readable data formats (ex: xls or csv or xml). In practice however valuable data may be computer-extracted even from formats that are conventionally considered non-machine-readable. For example, a PDF file is considered today non-machine-readable but it is possible to extract and put to good use e.g. as described herein, valuable metadata information e.g. the name of the author of the document, the date when the document was published, the title of the document, the government organization that published this PDF document. So, the software platform is typically designed to support expanding the number of component-types that can be accommodated including extracting metadata therefrom. For example, data might need to be in machine-readable formats in some embodiments, but metadata that describes the data can be extracted from formats including some that are considered ‘non-machine-readable’.
open data properties that may govern the design of the system herein may include some or all of:
1. open data is required to have a catalog.
2. the quality of the metadata is uneven over the universe of open data as a whole, but tends to be even within the agency, which generates the catalog.
3. the quality of the metadata tends to be higher when a low-level agency generates the catalog.

‘Metadata quality’ may be measured in terms of some or all of completeness, accuracy, and timeliness e.g:
Completeness—did the author of the open data publication provide as much information for as many as possible metadata-fields? For example, in a data.json catalog, an open data publication has fields for ‘spatial’, ‘temporal’ to state what geography the publication covers and what period. Likewise, there are fields that empower the author of the open data to provide ‘keywords’ (see here for the schema of data.json and its fields): https://project-open-data.cio.gov/v1.1/schema/. The author may provide values for a few fields with most fields optional. So, ‘completeness’ is typically about how much information for how many metadata-fields the end-user provided.
Accuracy—Did the author of the open data publication provide correct information for a given field? So, for example, the author might have written ‘Paris, France’ in the ‘spatial’ field but the data is really about Austin Tex. In this case the ‘spatial’ field is complete but not accurate.
Timeliness—How up to date is the metadata information? Often, authors upload an open data publication with its metadata and never return to update the metadata. The metadata becomes stale i.e. Low in timeliness.

In contrast to “open data” (e.g. as described in memorandum M-13-03) “closed data” is typically not published on the web for people to use free of charge, in a machine-readable format, and with a free license to use the information for different needs. “Closed data” is data that organizations (including government agencies) collect, generate, store, maintain and the system described herein according to some embodiments is also operative for crawling and de-duping metadata about ‘closed data’. For example, if the agency/organization complies with the standards set by M-13-03 or generally is bound to publishing their data through well-defined catalogs, the system herein may be configured to process this data. For example, NASA (or any other agency) may install a software platform based on the teachings herein inside their agency to crawl on NASA's internal servers in search for data, which is open inside NASA, and published via open data catalogs that other NASA departments and sub-organizations can view and download the data. The system herein may be used to generate for NASA a complete catalog of all its internal open data publications. one example of a format that this system may crawl and de-dupe is Socrata (software that helps cities, government agencies and other organizations create quickly open data portals and publish catalogs and publications). Socrata supports a binary Y/N feature that empowers their client-organizations to use a single format (ckan) to create ‘closed data’ repositories of publications and ‘open data’ repositories of publications. The Y/N binary switch then functions as a “switch” which determines whether or not end-users outside the agency/organization can also view publications.

It is appreciated that any distributed queue management scheme may be used for the system of FIG. 1, such as—by way of example—Bog standard AMQP, using rabbitmq.
in FIGS. 2a, 2b, the root url may include the URL fed in as input e.g. a URL with an empty path segment, such as http://data.gov/or http://data.nasa.gov/. However, e.g. for specialized crawlers, it is possible to feed in a longer path segment, such as http://example.com/data/catalog. The source url may include the URL that had a link to the current URL. The source URL is used to track whether or not a publication page has been found; if so, the page that referred to the publication page is reported as a catalog or suspected catalog.
It is appreciated that FIGS. 2a, 2b ma y be used for handling of cached/already crawled results. Typically, the cache may be used to ensure that pages already seen or those, which have not changed, since last seen, are not re-downloaded. According to some embodiments, links from such pages may however be re-crawled.

According to some embodiments the system differentiates between component level metadata, publication level metadata, and catalog level metadata. This is advantageous to allow data to be properly defined and manipulated. For example, a Romanian-language catalog may be discovered on the web and found to include a Russian-language publication having an English-language component. Therefore, language metadata is preferably defined at all 3 levels (catalog, publication and component) in order to register this catalog correctly e.g. in the database/s of FIG. 1.

Rather than merely involving publication level metadata, at least one of component level metadata and catalog level metadata is/are provided each with a predetermined structure. It is appreciated that catalog level metadata may be entered even manually, rather than being automatically generated, since this level is typically orders of magnitude smaller than the number of publications (e.g. <1000 catalogs worldwide). Catalogs may have possession of “potential” catalog-level metadata, which has not been structured as metadata. For example, catalogs often copy paste from older systems into a catchall description field.

According to some embodiments, a website is provided which, using the systems and methods described herein in its backend, enables data e.g. open data from government sources to be efficiently accessed.
One possible format that the system may crawl and/or discover relationships for and/or de-dupe is Socrata. Socrata supports a Y/N feature (binary) that empowers their client-organizations to use a single format (ckan) to create ‘closed data’ repositories of publications and ‘open data’ repositories of publications. Socrata does not consolidate catalogs, instead merely operating an open data catalog/portal conventionally for public/internal use. Socrata expose a data.json catalog, which allows the system herein to consume their clients' catalogs.

According to some embodiments, the system shown and described herein is operative to unite the metadata about the same information asset that appears in multiple open data portals. Uniting metadata may employ any suitable methods e.g. use of pre-generated ontologies or translation to enhance compatibility of metadata including variable/parameter/field/table names thereof; filling in missing metadata if one instance of an information asset has metadata that another instance lacks, and use of any suitable set of predetermined logical rules to determine how to combine (or use only one of) 2 non-identical instances of metadata e.g. one instance of an information asset indicates the author to be “John Smith and Mary Jones” whereas the other indicates the author to be “John Smith and Stanislaw Fields” and still another instance has “John Smith and Mary Jones and Maria Toledano”. A rule might be to always report a union of all authors in all instances of an information asset e.g. the information asset's author might be John Smith and Mary Jones and Stanislav Fields and Maria Toledano.” It is appreciated that the above is but one example of application of a predetermined rule to unify existing metadata harvested from the web; any other suitable rule may be implemented for metadata unification.

It is appreciated that the various embodiments described herein overcome various computer-technology related problems including consolidation of data, and converting metadata into an efficient common format. distributed crawling, distributed locking, integration with many APIs, automatic fixing of syntax errors may be overcome for many catalogs. Some embodiments effectively yield data compression in aggregate, because the underlying data need not be stored—only the metadata. Even if the metadata is stored in duplicate so as to retain a history, data compression is achieved. error detection and correction may be provided at least for common recoverable syntax errors such as prefixing with a UTF BOM mark, or using TRUE instead of true (JSON is case sensitive), say if specific catalogs are to be included for a specific academic project.

The flow, flow1, of FIGS. 6, 9 may be combined with the flow of FIG. 2a or of FIG. 2b. In other words, operations in FIG. 6a-6b or 9 may respectively be replaced by corresponding operations in FIG. 2a or 2b.

The flow, flow2, of FIGS. 7, 8 may be combined with the flow of FIG. 3a or of FIG. 3b. In other words, operations in FIG. 7 or 8 may respectively be replaced by corresponding operations in FIG. 3a or 3b.

It is appreciated that utilization of the crawling and/or deduping (aka detection of duplication and other relationships between publications) saves system time.

### Example

An end-user needs data about grain consumption in Canada. She types “Canada and grain consumption” in a Google search-box. Google reports that information about grain consumption in Canada is available from the following organizations:
IndexMundi contains detailed country statistics, charts, and maps compiled from multiple sources (http://www.indexmundi.com/)
Canadian Grain Commission—https://www.grainscanada.gc.ca/industry-industrie/ifim-mrdi-eng.htm
The Whole Grains Council (http://wholegrainscouncil.org/)
Canadian Wheat Board (http://www.mapleleafweb.com/features/canadian-wheat-board)
Statistics Canada (http://www.statcan.gc.ca/)

Absent the teachings herein, the end-user proceeds to visit each organization above in order to download data files—multiple times from each organization. The end user also launches refined queries separately for each of the aforementioned organizations. It is appreciated that an end user may launch many queries—separately for each organization—when researching the spatial, temporal and subject matters of a given publication. Similarly, the end user is likely to download many files.

In contrast, the crawling and/or deduping methods herein would allow a software system to automatically discover that the same information asset is described, using different metadata, by all 4 of the above agencies and commissions. Therefore, the system described herein supports providing this end-user with a different result than that described above namely unified metadata from multiple components of multiple information assets available from multiple (5, in the current example) organizations. There may be but a single entry provided by a search engine performing crawling and/or deduping methods herein, to the end-user above. This entry would point to a single information asset that describes Canadian grain consumption by year and by type of grain between 1960 and 2016. The search engine may for example point the end-user to a single instance of this information asset selected from among the plural e.g. 5 instances available from the 5 organizations above respectively—but the metadata provided to the end-user may not be the metadata stored by the, say, organization 5 (Statcan) whose information asset instance is selected. Instead, the metadata provided in conjunction with the statcan instance of the information asset may be unified from the respective 5 sets of metadata included in the 5 instances of the single information asset discovered in 5 different internet locations.

So, a search engine or other software system employing any of the crawling and/or deduping methods herein may save either or both (depending on whether end users are working in a querying-only mode or in a querying-and-downloading mode) of
a. machine-processing time (by allowing queries to be focused on single search result rather than, in the above example, 5 or more search results) and
b. bandwidth (less downloading).
c. scarce system-resources e.g. downloading bandwidth and CPU/processing for querying

This is the case for each end-user—whereas typically a single system is used worldwide by many projects, with many end-users and sessions per project. For example, a huge number of end-users worldwide are known to work with open datasets at all levels of government, as is evident from statistics published by UK and UN bodies that maintain open data. Savings are typically greater for users with many queries and many sessions

The saving in system time occurs because plural conventional e.g. Google (say) queries, plus browsing of open data portals (e.g. the web location http://www.data.gov for the USA federal open data portal, and so forth), is replaced by a more efficient process. Referring again to the end user seeking data on Canadian grain production, a single search query (e.g. “grain production in Canada”) may suffice, to a search-engine using the system and methods described herein to obtain a single information asset including spatial, temporal, and keywords metadata that renders the information asset useful, that the search-engine has assembled from the plural appearances of this information assets in the plural available open data portals.

The more efficient process typically includes preprocessing as described herein (crawl and/or publication relation discovery) followed by but a single search on an internet service based on the methods shown herein, then simply clicking on related links found by the internet service. So 5:1 on the search end of things, plus some constant for the actual process itself.

From the point of view of user experience, use of the system described herein saves considerable time for the user and improves the quality of research for users who are not aware of all the available authoritative data sources which relate to his query. In contrast, the system herein may be used for identifying all duplicates or other related bodies of data, for a body of data that is of interest.

It is appreciated that the system shown herein may generate these savings for many uses of existing cataloged data repositories. To give another example among very many, end users might be researching locations of all hospitals in a particular region such as, say, Italy, but this data (information asset) may be published—in varying languages/degrees of specificity by all of the following: various local municipalities, various regional governments, at least one agency in the state government and at least one international level organization e.g. the World Heath Organization.

It is appreciated that the system shown and described herein may provide a direct link from one instance of an information asset to other detected instances thereof (other duplicates thereof e.g.), whereas absent the system (and methods) shown herein, the end user seeking the data she or he needs may need to open each site and repeat her or his search (possibly using different terms, a problem which is resolvable within the system herein by adding an ontology of synonyms and/or a translation functionality). This cumbersome conventional session typically yields slow progress or failure to identify the proper data entirely.

Typically, system not end user is operative to assemble metadata about the same information asset that appears in multiple open data portals with variations in the metadata that describes it. For example, at the federal portal, the metadata might describe the agency responsible for the dataset. In a USAID open data portal, the same dataset might appear without the agency information but with temporal and spatial metadata. system time is saved because many end-users do not have to launch many queries and download a lot of data and nonetheless are apprised re, say, what this dataset is about, what period and geographies the dataset covers, what is the open data license that goes with the dataset. End user can then and go straight to the dataset needed, download just that dataset and work efficiently.

This may yield a system time saving of at least 5:1 relative to typing in a search engine e.g. Google, say, “Grain production in Canada”, then launching five or six queries, one per each portal where the same dataset about Grain Production in Canada appeared but with slightly different metadata.

It is appreciated that terminology such as “mandatory”, “required”, “need” and “must” refer to implementation choices made within the context of a particular implementation or application described here within for clarity and are not intended to be limiting since in an alternative implantation, the same elements might be defined as not mandatory and not required or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order including simultaneous performance of suitable groups of operations as appropriate; machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently rather than sequentially as shown; a computer program product including a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform e.g. in software any operations shown and described herein; information storage devices or physical records, such as disks or hard drives, causing at least one computer or other device to be configured so as to carry out any or all of the operations of any of the methods shown and described herein, in any suitable order; at least one program pre-stored e.g. in memory or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g. by one or more processors. Some embodiments shown and described herein may include (a) using a computerized method to identify a solution to any of the problems or for any of the objectives described herein, the solution optionally include at least one of a decision, an action, a product, a service or any other information described herein that impacts, in a positive manner, a problem or objectives described herein; and (b) outputting the solution.

The system may if desired be implemented as a web-based system employing software, computers, routers and telecommunications equipment as appropriate.

Any suitable deployment may be employed to provide functionalities e.g. software functionalities shown and described herein. For example, a server may store certain applications, for download to clients, which are executed at the client side, the server side serving only as a storehouse. Some or all functionalities e.g. software functionalities shown and described herein may be deployed in a cloud environment. Clients e.g. mobile communication devices such as smartphones may be operatively associated with but external to the cloud.

The scope of some embodiments of the presently disclosed subject matter is not limited to structures and functions specifically described herein and is also intended to include devices which have the capacity to yield a structure, or perform a function, described herein, such that even though users of the device may not use the capacity, they are if they so desire able to modify the device to obtain the structure or function.

Features of some embodiments, including operations, which are described in the context of separate embodiments, may also be provided in combination in a single embodiment. For example, a system embodiment is intended to include a corresponding process embodiment and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art and particularly although not limited to those described in the Background section or in publications mentioned therein.

Conversely, features of some embodiments, including operations, which are described for brevity in the context of a single embodiment or in a certain order may be provided separately or in any suitable sub-combination, including with features known in the art (particularly although not limited to those described in the Background section or in publications mentioned therein) or in a different order. “e.g.” is used herein in the sense of a specific example, which is not intended to be limiting. Each method may include some or all of the operations illustrated or described, suitably ordered e.g. as illustrated or described herein.

Devices, apparatus or systems shown coupled in any of the drawings may in fact be integrated into a single platform in some embodiments or may be coupled via any appropriate wired or wireless coupling such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations there within, and functionalities described or illustrated as methods and operations there within can also be provided as systems and sub-units thereof. The scale used to illustrate various elements in the drawings is merely exemplary and/or appropriate for clarity of presentation and is not intended to be limiting.

1-42. (canceled)

43. A system which automatically identifies catalogs running on a host in a network environment by crawling websites, the system comprising:
a site poker that includes a specialized crawler that identifies specialized catalog software running on a server;
crawler/s operative to extract metadata from a given catalog platform for computer storage, including functionality for at least one of:
marking in the computer storage, where that metadata came from; functionality for associating additional catalog level metadata with the metadata extracted; functionality for marking external links for feeding at least some of the external links back into the site poker; and
metadata extraction functionality that searches for at least one of RDF tags, other standard formats of linked metadata;
wherein if such metadata is found, a catalog is reported;
wherein if more than a predefined number of pages describe a single publication, the systems is configured for searching for pages that link to a plurality of publications and marking the pages as “catalog” pages;
wherein the systems is also configured for detecting metadata markers indicative of known catalog software; and
wherein the poker attempts to retrieve content from well-known locations of catalog software within a system and if these attempts are successful, the URLs thus retrieved are reported as catalogs.

44. The system according to claim 43, wherein the catalog level metadata identifies the computerized entity, which published the catalog.

45. The system according to claim 43, wherein the crawler comprises a generic html crawler.

46. The system according to claim 43, further comprising accommodating for open data republished on multiple catalogs, with varying metadata by de-duplication using message digests.

47. The system according to claim 43, further comprising reconciling and combining metadata from plural publications of the same information asset which have been identified.

48. The system according to claim 43, further comprising storing relationships between publications, then identifying similar data and recommending the similar data to end-users.

49. The system according to claim 48, wherein the recommending comprises prompting a user to view the same data from a different year.

50. The system according to claim 48, wherein the recommending comprises prompting a user to view the same data from a neighboring region.

51. The system according to claim 43, wherein the catalog software is identified by attempting to access known URL patterns.

52. The system according to claim 43, wherein the catalog software is identified by examining server responses for “fingerprints” such as but not limited to at least a portion of an http response.

53. The system according to claim 43, wherein the catalog software comprises at least one of CKAN, data.json.

54. A method which automatically identifies catalogs running on a host in a network environment by crawling websites, the method including:
discovering at least one catalog;
crawling publications from the at least one catalog and report the publications to a staging system;
discovering relationships between publications thus reported to the staging system;
providing an output indication of a catalog list including all discovered information catalog systems and their URLs within that domain; and
listing all external domains linked to from this domain.

55. A method which automatically identifies catalogs running on a host in a network environment by crawling websites, the method for at least one domain comprising:
downloading pages,
adding discovered links back to a queue;
reporting publications to a staging system,
providing an output indication of a catalog list including all discovered information catalog systems and their URLs within that domain, and
listing all external domains linked to from this domain.

56. The system according to claim 43, being configured to differentiate between at least 2 of component level metadata, publication level metadata, and catalog level metadata.

57. The system according to claim 43, wherein at least one of component level metadata and catalog level metadata are provided each with a predetermined structure.

58. A computer program product that includes a non-transitory tangible computer readable medium having computer readable program code embodied therein, the computer readable program code adapted to be executed to implement a method which automatically identifies catalogs running on a host in a network environment by crawling websites, the method comprising:
discovering at least one catalog;
crawling publications from the at least one catalog and report the publications to a staging system;
discovering relationships between publications thus reported to the staging system;
providing an output indication of a catalog list including all discovered information catalog systems and their URLs within that domain; and
listing all external domains linked to from this domain.

59. The method according to claim 55, further comprising reporting errors occurring while crawling at least one catalog.

60. The method according to claim 54, wherein the discovering comprises at least one of: downloading pages; adding discovered links back to the queue; and reporting publications to a staging system.

61. The method according to claim 60, further comprising adding the number of publications/metadata/catalogs.

62. The system according to claim 52, wherein the http response comprises an X-CKAN-API header.

63. A computerized relationship discovering method, comprising:
generating a list of “potential” publications, which may have some relationship to a current publication;
for each pairing of current publication and potentially related publication examining available metadata which pertains to the relevant publications, to determine relationships between publications and storing relationship/s with references to both publications;
tracking behavior of end users who search through information assets the system has discovered, and use for creating relationships between publications;
using specific information known about a user's downloading behavior to mark relationship/s as stronger or weaker reflected in high/low confidence levels where relationships whose confidence exceeds a threshold are stored; and
de-duping publications thereby to generate a set of information assets;
wherein user behavior is tracked and is used for creating relationships between publications including using at least one of the following as evidence of a relationship between publications 1, 2:
temporal adjacency of searches yielding publications 1, 2 as respective search results;
downloading publications 1, 2 in a single session; and
purchasing publications 1, 2 in a single session.

64. The method according to claim 63, further comprising, for each new or updated publication reported to the staging system, scheduling the publication's links for component crawling, and for relationship discovery.

65. The method according to claim 63, further comprising attempting to download the links from the publication.

66. The method system according to claim 55, further comprising providing an output indication of a catalog list including all discovered information catalog systems and their URLs within that domain.

67. The method according to claim 63, further comprising scheduling each publication for advanced metadata extraction including at least one of machine-translating into a common language and/or extracting additional metadata fields.

68. The method according to claim 63, wherein relationship discovery is applied over all catalogs.

69. The method according to claim 55 comprising, in a set-up stage, compiling a list of websites on which to perform relationship discovery.

70. The method according to claim 55, further comprising crawling discovered URLs so as to report existence of catalogs at certain URLs by noting indications of standard catalog software.

71. The method according to claim 55, further comprising link processing for at least some links wherein each page found to contain a predefined number of publication links is marked as a “generic” catalog.

72. The method according to claim 55, further comprising metadata extraction that searches for at least one of RDF tags, other standard formats of linked metadata and wherein if such metadata is found, a catalog is reported.

73. The method or system according to claim 72, wherein, otherwise, DOM of HTML is traversed to find a common unit of analysis in the page such that it appears that the content is describing one link exactly.

74. The method or system according to claim 73, wherein, if no such common unit of analysis can be found, current page is considered a page describing a single publication.

75. The method or system according to claim 74, wherein, a common unit of analysis if found is reported as a catalog page.

76. The method according to claim 55, further comprising searching, if more than a predefined number of pages describe a single publication, for pages that link to a plurality of publications and marking the pages as “catalog” pages.

77. The method according to claim 55, further comprising detecting metadata markers indicative of known catalog software.

78. The method according to claim 55, further comprising at least one attempt to retrieve content from known locations of catalog software which if successful, triggers a report of these URLs as catalogs.

79. The method according to claim 55, further comprising identifying duplicate catalogs within pages marked as a “generic catalog”, selecting one, from among duplicate catalogs identified, and reporting others to staging system as duplicate catalogs.

80. The method according to claim 55, further comprising attempting, if this catalog has been crawled in the past, to compare catalog publication/s to seemingly corresponding publications in history repository and reporting changes if any in the catalog makeup of the system.
